(19) United States
(12) Patent Application Publication
(10) Pub. No.: US 2026/0353048 A1
(43) Pub. Date: Nov. 5, 2026

(54) WIRELESS INTERFACING SYSTEM AND ASSOCIATED METHOD

(71) Applicant: GPHY INC., Quebec (CA)

(72) Inventors: Hubert AUDET, Quebec (CA); Anthony BLAIS, Quebec (CA); Pier-Etienne LEHOUX, Montmagny (CA)

(73) Assignee: GPHY INC., Quebec, QC (CA)

(21) Appl. No.: 19/488,827

(22) PCT Filed: May 31, 2024
(86) PCT No.: PCT/CA2024/050732

§ 371 Date: Nov. 29, 2025

Related U.S. Application Data
(60) Provisional application No. 63/505,465, filed on Jun. 1, 2023.

(51) Int. Cl. H04W 4/38; H04W 48/10; H04W 48/20; H04W 76/10

(52) U.S. Cl. CPC H04W 4/38; H04W 48/10; H04W 48/20; H04W 76/10

(57) ABSTRACT

Systems and methods to locate users in hybrid workplaces or coworking spaces via pairing of their portable devices with wireless communication devices with improved anti-cross-connection features are provided. A plurality of stateful wireless communication devices positioned at different locations in a venue are used. Each communication device includes a presence sensor to measure a presence detector signal value indicative of a presence being detected in a field of view of the presence sensor and a communication module to broadcast an advertisement signal at a set frequency in unpaired state. A stateful software application module is also for execution in each portable device. The software application includes a communication device detection submodule to detect nearby communication devices in unpaired state and a communication device selection submodule to select the closest communication device among the nearby wireless communication devices detected.

### CROSS-REFERENCE TO RELATED APPLICATION

This application claims the benefit of and priority to U.S. Provisional Patent Application No. 63/505,465, filed Jun. 1, 2023, and entitled “Wireless Interfacing System and Associated Method”, the disclosure of which is hereby incorporated by reference in its entirety.

### TECHNICAL FIELD

The present invention generally relates to methods and systems adapted to precisely locate individuals in a venue. The users are locatable via pairing of their portable devices with wireless communication devices. Data related to occupancy of the venue and user habits may also be provided.

### BACKGROUND

With the expansion of hybrid workplaces and coworking spaces, there is an increasing need for owners or managers of establishments such as restaurants, coffee shops, offices, schools, food courts, and many others, to acquire data on the usage of their spaces and furniture. Furthermore, owners or managers may want to use data to predict or monitor attendance and control various systems based on this localization or occupancy information. There is also a need to localize users at their current working stations in offices or working environment to address some challenges related to unassigned or shared desks and to facilitate communications. These challenges include reservation of places, such as working stations or offices, and localization of colleagues in large working environments. There may also be a need for the users to adjust electrical standing desk to a preferred height, for example, or other preferences such as local temperature, ventilation, and lighting, that can become cumbersome upon arriving at a working station or when switching working stations.

These needs can be solved to a point with existing systems that locate users via pairing of their portable devices with wireless communication devices. These systems have their own challenges, though. For instance, in some environments and for some computer models, measuring either the received signal strength indicator or the time of flight cannot be trusted to identify the wireless communication device closest to the workstation on which the portable device is currently located on. Therefore, a portable device could pair with the wrong wireless communication device, a phenomenon known as “cross-connection”. This must be limited to ensure the best user experience and accuracy of data from the desired features. There therefore remains a need for user location systems with improved anti-cross-connection features.

### SUMMARY

In accordance with an aspect, a system for wirelessly locating a plurality of users in a venue via their respective portable device is provided. The system includes a plurality of stateful wireless communication devices positioned at different locations in the venue. Each includes a presence sensor configured to measure a presence detector signal value indicative of a presence being detected or undetected in a field of view of the presence sensor, and a communication module configured to broadcast an advertisement signal at a set frequency when in a communication device unpaired state. The system also includes a database and a stateful software application module, each portable device being configured to execute the software application module. The software application module includes a communication device detection submodule configured to detect nearby wireless communication devices by the portable device when in a software unpaired state, and a communication device selection submodule configured to select a closest wireless communication device among the nearby wireless communication devices detected by the communication device detection submodule.

In some embodiments, the advertisement signal of each of the wireless communication devices comprises at least one of an indication of a state of the wireless communication device and a communication device identifier.

In some embodiments, possible states of each of the wireless communication devices includes a communication device standby state, being an initial state of each stateful wireless communication device upon startup, the communication device unpaired state, and a communication device paired state, wherein possible states of the software application module includes the software unpaired state, being an initial state of the software application module upon startup, and a software paired state.

In some embodiments, the presence sensor comprises at least one of an infrared sensor and a passive infrared sensor.

In some embodiments, each wireless communication device is configured to transition from the communication device standby state to the communication device unpaired state in response to the presence detector signal value corresponding to the presence being detected in the field of view of the presence sensor.

In some embodiments, the communication device detection submodule is configured to detect identifiers broadcast by the nearby wireless communication devices and measure a proximity indicator associated with each broadcast during at least one time period when the software application module is in the software unpaired state, and the communication device selection submodule is configured to aggregate a plurality of proximity indicators to select the closest wireless communication device among the nearby wireless communication devices by a pairing condition.

In some embodiments, the proximity indicator comprises at least one of a received signal strength indicator and a time of flight.

In some embodiments, the software application module includes a pairing submodule configured to establish a pairing between a portable device and the closest wireless communication device, wherein in response to establishing the pairing the software application module transitions from the software unpaired state to the software paired state and the closest wireless communication device transitions from the communication device unpaired state to the communication device paired state.

In some embodiments, the pairing submodule is configured to maintain the pairing between the portable device and the closest wireless communication device while the software application module is in the software paired mode.

In some embodiments, each wireless communication device is configured to transition from the communication device paired state to the communication device standby state in response to a communication device unpairing condition being detected.

In some embodiments, the software application module is configured to transition from the software paired state to the software unpaired state in response to a software unpairing condition being detected.

In some embodiments, each wireless communication device is configured to cease broadcasting the advertisement signal in response to entering the communication device paired state.

In some embodiments, each wireless communication device is configured to broadcast the advertisement signal when in the communication device paired state.

In some embodiments, the system includes at least one gateway configured, in response to receiving the advertisement signal from one of the wireless communication devices, to transmit at least the state of the wireless communication device to the database.

In some embodiments, each wireless communication device is configured to transition from the communication device unpaired state to the communication device standby state after a predetermined duration in the communication device unpaired state.

In some embodiments, each wireless communication device is configured to cease broadcasting the advertisement signal temporarily for a first predetermined duration after a second predetermined duration when in the communication device unpaired state with the presence detector signal value corresponding to the presence being detected in the field of view of the presence sensor.

In some embodiments, the software application module is configured to validate the pairing repetitively while in the software paired state.

In some embodiments, the presence sensor is configured to acquire a count of a number N of users in a room, a subset of the wireless communication devices located in the room being configured to transition from the communication device unpaired state to the communication device paired state once the subset of the wireless communication devices is paired with N portable devices.

In some embodiments, the software application module includes a registration submodule configured, in response to entering the software paired state, to transmit at least one of an identifier corresponding to the closest wireless communication device, and an identifier corresponding to the portable device to the database.

In some embodiments, the software application module further includes a login submodule configured to identity a user using the portable device, and wherein the registration submodule is further configured, in response to entering the software paired state, to transmit an identifier corresponding to the user to the database.

In some embodiments, the software application module further comprises a login submodule configured to identity a user using the portable device.

In some embodiments, the database is configured to store at least one of an identifier corresponding to the closest wireless communication device and an arrival timestamp.

In some embodiments, the presence detector signal value is indicative of a presence being detected in a field of view of the presence sensor if the presence detector signal value meets a presence condition based on a reference value.

In some embodiments, at least one of the wireless communication devices is configured to adjust the reference value periodically.

In some embodiments, adjusting the reference value comprises aggregating at least one past reference value and the presence detector signal value.

In some embodiments, the aggregating is based at least in part on a plurality of discrete weight values, each weight value being associated with a range of difference between the presence detector signal value and the reference value.

In some embodiments, the aggregating is based at least in part on a continuous function mapping a difference between the presence detector signal value and the reference value to a discrete weight.

In some embodiments, the aggregating is based at least in part on a derivative of the presence detector signal value.

In accordance with another aspect, a method for wirelessly locating a plurality of users in a venue via their respective portable device is provided. The method includes measuring, by a presence sensor of each of a plurality of stateful wireless communication devices positioned at different locations in the venue, a presence detector signal value indicative of a presence being detected or undetected in a field of view of the presence sensor, broadcasting, by each of the plurality of stateful wireless communication devices, an advertisement signal at a set frequency when the wireless communication devices is in a communication device unpaired state, detecting, by a stateful software application module running on each portable device, nearby wireless communication devices by the portable device when the software application module is in a software unpaired state, and selecting, by the software application module, a closest wireless communication device among the nearby wireless communication devices.

In some embodiments, the advertisement signal of each of the wireless communication devices comprises at least one of an indication of a state of the wireless communication device and a communication device identifier.

In some embodiments, possible states of each of the wireless communication devices include a communication device standby state, being an initial state of each stateful wireless communication device upon startup, the communication device unpaired state and a communication device paired state, and possible states of the software application module include the software unpaired state, being an initial state of the software application module upon startup; and a software paired state.

In some embodiments, the presence sensor comprises at least one of an infrared sensor and a passive infrared sensor.

In some embodiments, the method includes each wireless communication device transitioning from the communication device standby state to the communication device unpaired state in response to the presence detector signal value corresponding to the presence being detected in the field of view of the presence sensor.

In some embodiments, the method includes detecting, by the software application module, identifiers broadcast by the nearby wireless communication devices and measuring a proximity indicator associated with each broadcast during at least one time period when the software application module is in the software unpaired state, and aggregating, by the software application module, a plurality of proximity indicators to select the closest wireless communication device among the nearby wireless communication devices by a pairing condition.

In some embodiments, the proximity indicator comprises at least one of a received signal strength indicator and a time of flight.

In some embodiments, the method includes establishing, by the software application module, a pairing between a portable device and the closest wireless communication device, wherein in response to establishing the pairing the software application module transitions from the software unpaired state to the software paired state and the closest wireless communication device transitions from the communication device unpaired state to the communication device paired state.

In some embodiments, the method includes maintaining, by the software application module, the pairing between the portable device and the closest wireless communication device while the software application module is in the software paired mode.

In some embodiments, the method includes transitioning, by each wireless communication device, from the communication device paired state to the communication device standby state in response to a communication device unpairing condition being detected.

In some embodiments, the method includes transitioning, by the software application module, from the software paired state to the software unpaired state in response to a software unpairing condition being detected.

In some embodiments, the method includes ceasing, by each wireless communication device, broadcasting the advertisement signal in response to entering the communication device paired state.

In some embodiments, the method includes broadcasting, by each wireless communication device, the advertisement signal when in the communication device paired state.

In some embodiments, the method includes transmitting, by at least one gateway, at least the state of the wireless communication device to a database in response to receiving the advertisement signal from one of the wireless communication devices.

In some embodiments, the method includes transmitting, by the software application module, at least one of an identifier corresponding to the closest wireless communication device, and an identifier corresponding to the portable device to a database in response to entering the software paired state.

In some embodiments, the method includes identifying, by the software application module, a user using the portable device, and transmitting, by the software application module, an identifier corresponding to the user to a database in response to entering the software paired state.

In some embodiments, the database is configured to store at least one of an identifier corresponding to the closest wireless communication device and an arrival timestamp.

In some embodiments, the method includes transitioning, by each wireless communication device, from the communication device unpaired state to the communication device standby state after a predetermined duration in the communication device unpaired state.

In some embodiments, the method includes comprising ceasing, by each wireless communication device, broadcasting the advertisement signal temporarily for a first predetermined duration after a second predetermined duration when in the communication device unpaired state with the presence detector signal value corresponding to the presence being detected in the field of view of the presence sensor.

In some embodiments, the method includes comprising validating, by the software application module, the pairing repetitively while in the software paired state.

In some embodiments, the presence sensor is configured to acquire a count of a number N of users in a room, comprising transitioning, by a subset of the wireless communication devices located in the room, from the communication device unpaired state to the communication device paired state once the subset of the wireless communication devices is paired with N portable devices.

In some embodiments, the software application module is further configured to identity a user using the portable device.

In some embodiments, the presence detector signal value is indicative of a presence being detected in a field of view of the presence sensor if the presence detector signal value meets a presence condition based on a reference value.

In some embodiments, the method includes adjusting, by at least one of the wireless communication devices, the reference value periodically.

In some embodiments, adjusting the reference value comprises aggregating at least one past reference value and the presence detector signal value.

In some embodiments, the aggregating is based at least in part on a plurality of discrete weight values, each weight value being associated with a range of difference between the presence detector signal value and the reference value.

In some embodiments, the aggregating is based at least in part on a continuous function mapping a difference between the presence detector signal value and the reference value to a discrete weight.

In some embodiments, the aggregating is based at least in part on a derivative of the presence detector signal value.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1A is a schematic illustration of components of a localization system according to a possible embodiment.

FIG. 1B is another schematic illustration of components of a localization system according to a possible embodiment.

FIG. 2A is a functional block diagram of a wireless communication device according to a possible embodiment.

FIG. 2B is a schematic diagram of a software application module provided that can be installed on a portable device, according to a possible embodiment.

FIG. 3 is a functional block diagram of a localization system, according to a possible embodiment.

FIG. 4 is a sequence diagram of steps done by a wireless communication device according to a possible embodiment.

FIG. 5 is a state diagram of a localization system, according to a possible embodiment.

FIG. 6A is an illustration showing locations within a venue wherein the methods and systems described herein can be implemented.

FIG. 6B is an illustration showing another venue wherein the methods and systems described herein can be implemented.

FIG. 7 is a schematic illustration of a page or pane of a graphical user interface, according to a possible embodiment.

FIG. 8 is a schematic illustration of another page or pane of the graphical user interface, according to a possible embodiment.

FIG. 9 is a schematic illustration of yet another page or pane of the graphical user interface, according to a possible embodiment.

FIGS. 10A and 10B are schematic illustrations of possible reports or graphs using acquired data from the methods and systems described herein.

FIG. 11 is a schematic illustration of yet another page or pane of the graphical user interface, according to a possible embodiment.

FIG. 12 is an organizational database diagram showing records and database tables containing data relating to users, external devices, interfacing devices and timestamps relating to the occupancy of a location within a venue, according to a possible embodiment.

It should be noted that the appended drawings illustrate only exemplary embodiments of the invention and are therefore not to be construed as limiting of its scope, for the invention may admit to other equally effective embodiments.

### DETAILED DESCRIPTION

In the following description, similar features in the drawings have been given similar reference numerals and to not unduly encumber the drawings, some elements may not be indicated in some figures if they were already introduced in a preceding figure. It should be understood that the elements of the drawings are not necessarily depicted to scale, since emphasis is placed on illustrating the elements and the interactions between elements.

The system and method presented herein relate to the management of venues or environments, such as offices, and the occupancy of these venues, using wireless transmitting devices placed at different locations of a venue. The connections and communications between the wireless transmitting devices and the portable devices of the users can be used to locate users within the venue, but also to collect statistical data on the occupancy of the venue and on user preferences, on a “per user” basis or for a group of users.

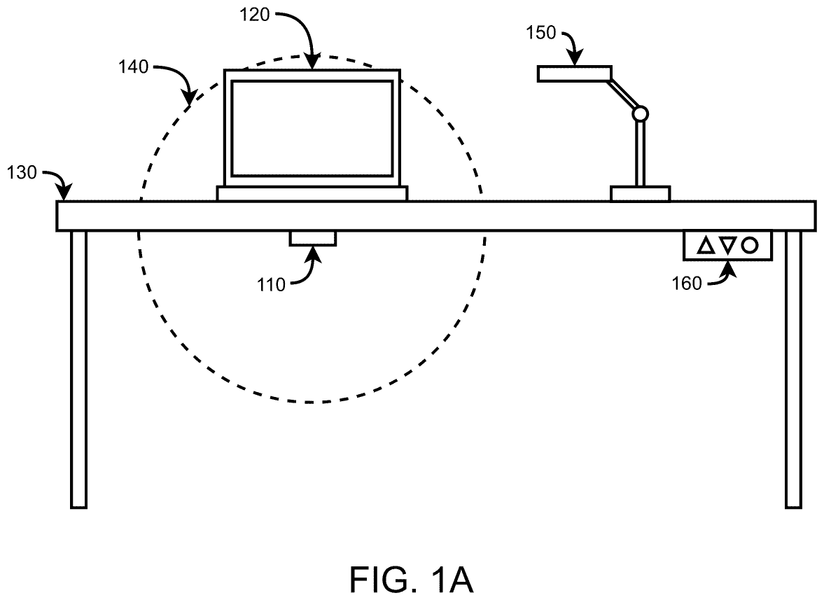

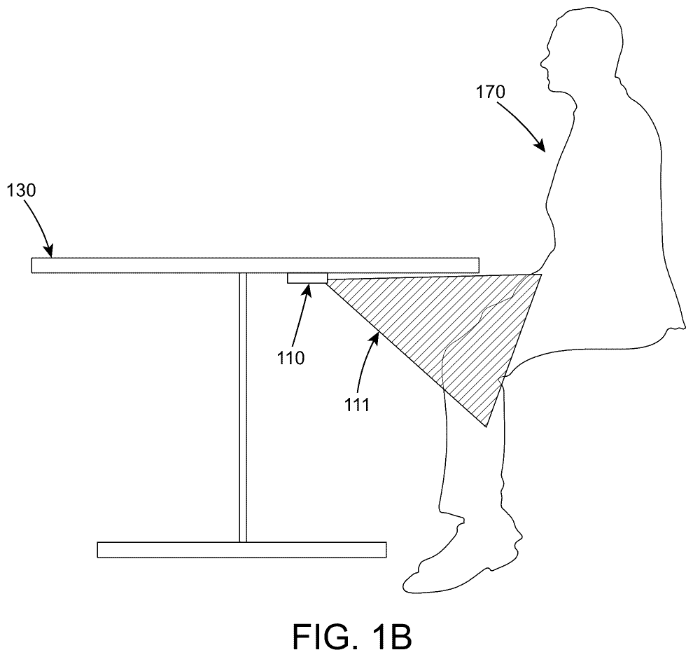

The system and method described in the present application thus relate to communication management and optimization. The exemplary systems and methods illustrated in FIGS. 1 to 12 are especially adapted for wireless work environments and shops. The portable devices of users may comprise, for example, laptops, personal data assistants, cellular telephones, smartphones, wearable devices, tablets or portable video game devices. The proposed system and method can be adapted to and used in different environments or venues, such as classrooms, public libraries, and airports, as examples only.

Broadly described, the proposed system comprises wireless communications devices for wirelessly locating a plurality of users in a venue via their respective portable device. The communication devices are configured to broadcast advertisement signals that are detected by a software module running on the portable devices of the users. By detecting the communication device closest to the portable device, the software module is able to determine the precise location of the user within the venue and transmit this information to a database.

In the present application, the term “portable device” refers to any type of portable processing device such as, without being limited to, portable computers, laptops, smart tablets, notebooks, smart phones and two-in-one laptops.

By “wireless communication device”, we refer to a device (or a set of components/modules) that is configured to wirelessly transmit identification-related (ID) information to a portable device, for instance allowing a software module installed on the portable device to determine where in a venue the portable device is located. A “wireless communication device” comprises the components to wirelessly transmits its corresponding identifier. In some embodiments, the wireless communication device may also receive information.

By “identification-related information” or “identifier”, we refer to any information that may be used to identify a wireless communication device, an external device, and any relevant device. The identification-related information may be an identification (ID), for instance a Tx ID for a wireless communication device, or information that can be used to retrieve an ID, such as an identification-related information that can be used for searching a database.

By “external device”, we refer to any device that is present in the environment but that it is not physically connected to the portable device and that is not a wireless communication device. Such external devices may include, without being limited to, a height-adjustable electrical desk, a lighting system, a heating or ventilation system, an electronic photo frame, electrical windows, or electric blinds. In the context of the present description, the “external devices” are devices with wireless communication capabilities. Further, in some embodiments, the external devices include peripheral devices, such as devices that may be connected to and interfaced with portable devices. Such peripheral devices may be, without being limited to, a display monitor, a computer monitor, a projector, any screen device, a television, a wireless mouse, a speaker, an audio system, and a wireless keyboard. In such embodiments, the peripheral devices are wireless devices. However, some peripheral devices are built without wireless capabilities. In such cases, external dongles may be connected to those peripheral devices to provide them with wireless communication capabilities needed to establish a wireless connection with a portable device. Those external dongles can thus be considered as peripheral devices in combination with the actual peripheral device (such as keyboards and mice). In other words, an external device does not necessarily need to interact with the portable device (for example a lamp, a desk or the heating system), while a peripheral device is typically used with the portable device (keyboard, mouse, display screen, speakers).

By “advertisement signal”, we refer to any type of message, signal or information that can be sent by a wireless communication device or a portable device to confirm its presence/pairing. The advertisement signal could be specific, containing identification-related information of, or an identifier corresponding to, a particular wireless communication device or portable device, for example. The advertisement signal could additionally or alternatively contain an indication of a state of the wireless communication device sending it. The advertisement signal may be broadcast by the wireless communication device. It may also be modified to not be processed by all devices.

By “control signal”, we refer to any type of message, signal or information that can be sent by the portable device to an external device. An exemplary control signal can be an activation command, which would activate or deactivate a functionality of the external device. Another exemplary control signal may be an adjustment command which would adjust a parameter of the external device to a desired value.

Referring now to FIG. 1A, there is presented a possible embodiment of a localization system. The system comprises a wireless communication device 110 who may be installed as shown herein under a desk 130. The wireless communication device 110 may detect or be detected by portable devices 120 entering its vicinity zone 140. The wireless communication device may also include a presence sensor and detect the presence of humans in its vicinity. The wireless communication device 110 can broadcast identification-related information using communication means, such as Ultra Wide Band (UWB), BLE (Bluetooth™ Low Energy) and Near Field Communication (NFC) chips or modules, the ID information being receivable by any portable device within the communication range of the wireless communication device, but destined to a portable device 120 that is located within a vicinity zone 140 of the wireless communication device.

As will become apparent in the following description, such devices as illustrated in FIG. 1A, when used with a database and with a software application module, allow to wirelessly locate users, via the connection of their portable devices with the wireless communication devices, in a venue where the devices are deployed, and allow gathering occupancy data of specific locations within the venue, as well as users' presence/time spent at specific locations within the venue.

Using the database and specific submodules of the software application, the identification-related information allows the portable device 120 to automatically exchange information or send instructions to the external device 150, such as a lamp provided with wireless communication capabilities. Information and instructions may also be sent to a plurality of external devices located on or near the interfacing station or in its neighbourhood. For example, in FIG. 1A, an external device consists of the table 130 which is an electric height-adjustable using a control panel 160. The control panel 160 may include wireless communication capabilities allowing the portable device 120 to wirelessly send instructions related to the desired height of the desk. In a preferred embodiment, the identification-related information transmitted by wireless communication device 110 allows the portable device 120 to automatically identify, and connect, directly or indirectly e.g., through a gateway, to the external device 150 located at the workstation 130. The portable device 120 can attempt to automatically connect to the external device 140 with wireless communication means, with or without the need for user authorization. When the connection is successful, the portable device 120 may then exchange instructions and information with the external device 150 through an established wireless communication means. Wireless communication means between the portable device 120 and the external device 150 may include, but are not limited to Wi-Fi, Bluetooth™, broadband cellular networks and any other communication means supported by the portable device and the external devices. The external device 150 not provided with wireless communication means may also be connected to an external dongle providing said wireless communications means.

External devices that can be activated or controlled by the portable device 120 when entering zone 140 include, without being limited to, electrically adjustable tables or desks, lighting systems, local heating or cooling systems (or air-temperature units), digital photo frames, or any other device with wireless communication capabilities. Settings of an external device that can be controlled by the portable device include, without being limited to, light intensity, light colour, desk height and temperature. The instructions sent to an external device can be based on user preferences associated with the portable device. For example, a person may prefer to keep the desk lamp off when he arrives at a working station, but another person may want to turn it on. Those preferences can be stored in a database, or on the portable device 120, for example. It will be noted that the user preferences can be associated with a user independently of a given portable device. Therefore, a user may use various portable devices while keeping the same user preferences, by logging into the software application module and accessing those user preferences on the portable devices, for example.

The wireless communication device 110 described herein is positioned under the workstation 130. However, in alternative embodiments, the wireless communication device 110 may be positioned on top of the workstation, or integrated to the workstation, for example.

Referring now to FIG. 1B, a side view of a wireless communication device 110 installed underneath a table 130 is shown according to an exemplary embodiment. When a person 170 comes to sit at the table or use it in any different way, the wireless communication device can detect the person presence using a presence sensor. If the person is inside the sensor field of view 111, the person is likely to be detected. The presence sensor may be placed inside the wireless communication device casing in a way that maximizes the field of view coverage for most ways that people sit or use the table. The position under the table may also be optimized in the same way. Alternatively, the sensor may be positioned externally with respect to the device casing, under the table 130 or in any other suitable position, and in wired or wireless communication with the device.

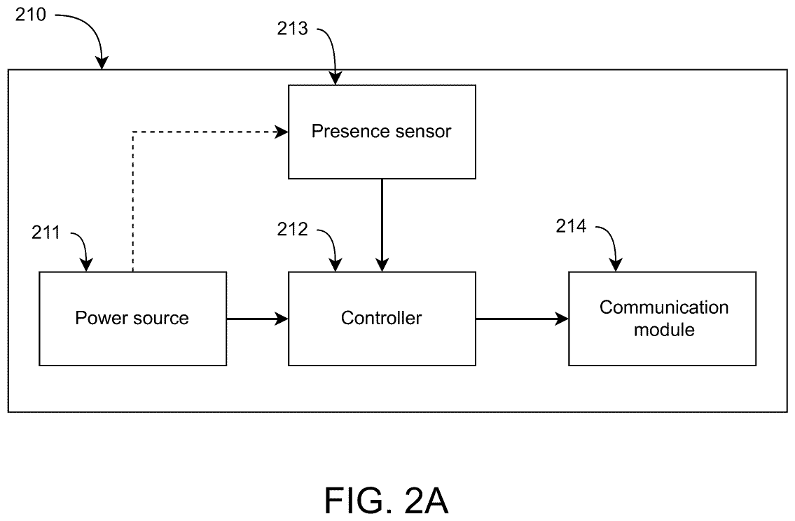

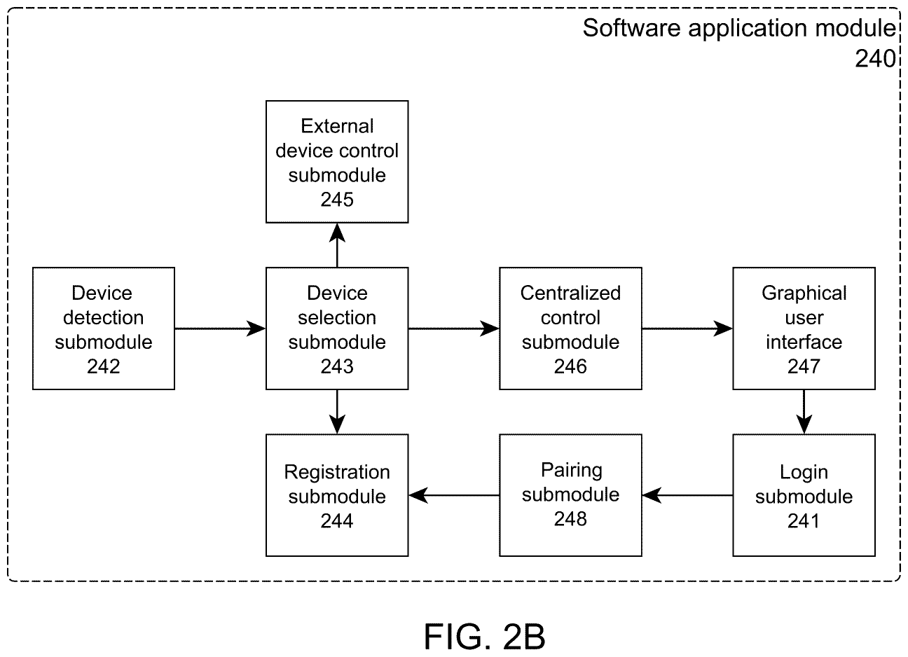

Referring now to FIG. 2A, a schematic block diagram of a wireless communication device 210 is shown according to an exemplary embodiment. A wireless communication device can include a power source 211 which may for example be a wired input or a battery. The power source may also include circuitry for the modulation of the power signal to various parts of the system. A controller 212 is powered by the power source 211 and may perform computing tasks, store information into its internal memory or external memory (not shown), interface sensors such as the presence sensor 213 and interface with a communication module 214. The presence sensor is a sensor that can detect the presence of a person in the vicinity of the wireless communication device 210. The presence sensor may for example include an infrared (IR) sensor, a passive infrared (PIR) sensor and/or an ultrasonic sensor. In some embodiments, multiple sensors can be combined to enhance the accuracy of presence detection. It can be appreciated that other types of sensors, including for instance sound and/or video capture devices, can be used cooperatively or alternatively to infrared sensors. In a possible embodiment where the wireless communication device is installed under a desk or table, as shown in FIG. 1A, the sensor may be installed in a way that the field of view of the sensor covers a person who is sitting or standing while using this table/desk. The presence sensor will create a presence detector signal of different values depending on whether someone is in its field of view. These signals may include analogical signals and/or digital signals, e.g., if the presence detector 213 includes an analogic-to-digital converter. The wireless communication device 211 may for example only send advertisement signals using the communication module 214 when the presence detector signal value meets a presence conditions, e.g., when it exceeds a defined threshold, or simply modify the advertisement signal according to the presence detector signal value. The communication module 214 is used to send signals to other devices using one of various communication protocols, including, but not limited to, Wi-Fi, Bluetooth™, and Bluetooth™ Low Energy (BLE) and UWB.

FIG. 2B shows a possible organization of the software application module 240 operating on portable device 120. It can be appreciated that all submodules can be implemented as part as one application or plugin, or that the functionalities implemented by the submodules may be distributed among more than one application and/or plugin, and that some or all functionalities may be implemented as part of a web application, accessible for instance via a web browser of portable device 120, and in which the some operations can be implemented on an external device such as for instance a server operating in the cloud or in the venue which executes an HTTP server to serve the web application to the portable device 120.

The software application module 240 can comprise a login submodule 241, which is configured to identify the user of the portable device 120. In some embodiments, the identification of the user is performed by requesting the user to enter a username and a password using a data entry device integrated in or coupled with the portable device 120. The username and/or password, or a string corresponding to the password such as a salted or unsalted hash, may for instance be stored in a database of the portable device 120 accessible by the login submodule 241 and/or in a database included in or accessible by a centralized server associated with the venue. Once a user has been authenticated and/or identified, the login submodule 241 may provide an identifier associated with the user, which can be stored in a database for instance to allow computing statistics about the user or to allow other individuals in the venue to find the user.

The software application module 240 can comprise a device detection submodule 242 (also named “communication device detection submodule”), which is configured to detect signals emitted or broadcast by nearby wireless communication devices. Nearby wireless communication devices can for instance include all wireless communication devices of which the portable device 120 is in communication range, for instance such that a communication module of the portable device 120 is capable of perceiving the signals broadcast by the wireless communication devices. The signals can for instance comprise radio signals corresponding to a wireless communication device broadcasting its identifier, a bidirectional wireless communication with the portable device 120. Once a signal is detected, parameters of this signal can be measured, including for instance a signal strength such as the RSSI of a radio signal, or a precise time of signal detection, which can be used as proximity indicators. The collected information can be transmitted to a device selection submodule 243.

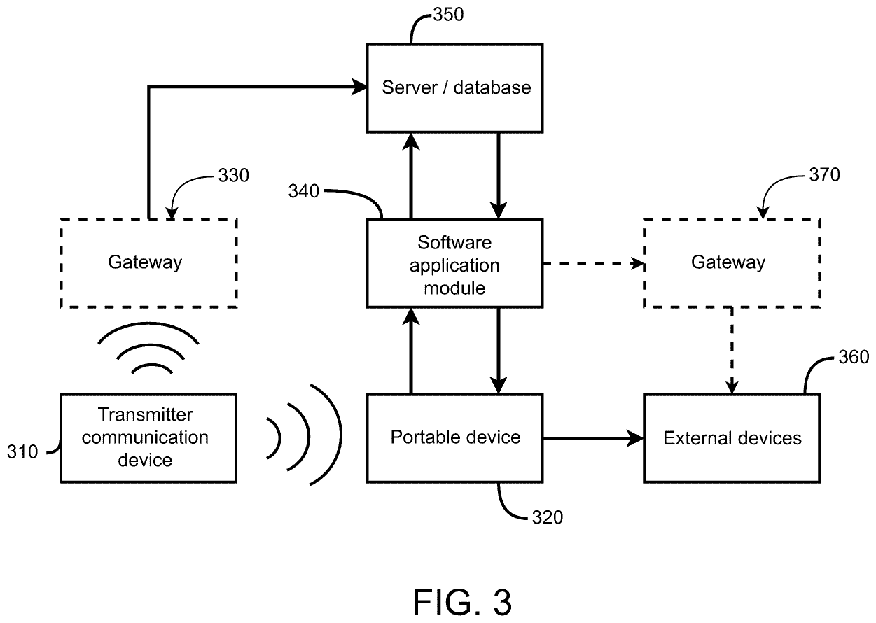

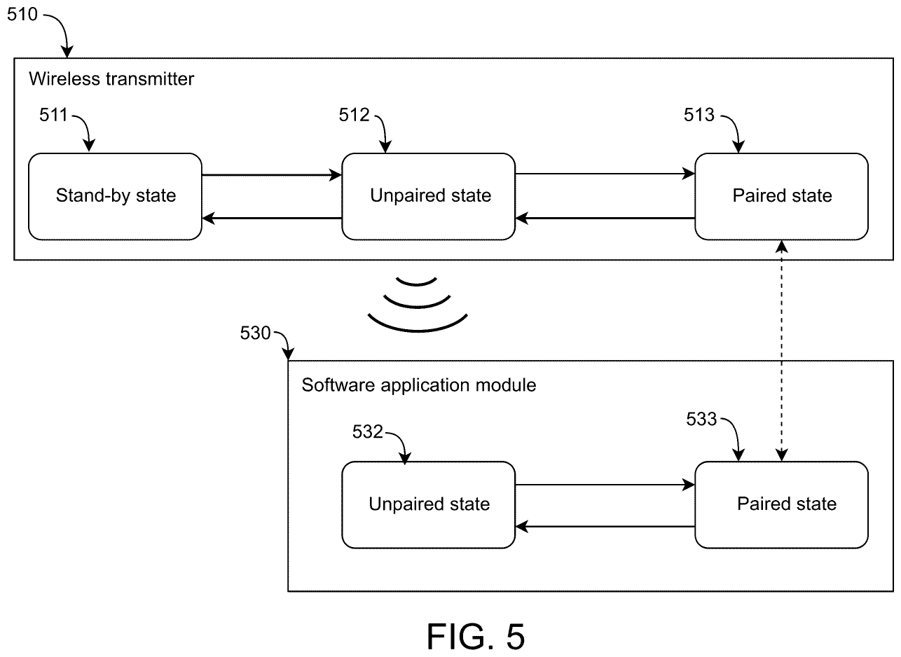

The software application module 240 can comprise a device selection submodule 243, which is configured to select the closest wireless communication device. The device selection submodule 243 can implement a number of techniques that will be described in detail below, in particular with respect to FIG. 3 to 5. Broadly described, the closest wireless communication device selected by the device selection submodule 243 can for instance correspond to the wireless communication device that has the strongest radio signal as averaged over one or more time periods or intervals, or to the wireless communication device that is paired with the portable device 120 following pairing validation and/or confirmation procedures described in detail below, in particular with respect to FIG. 5.

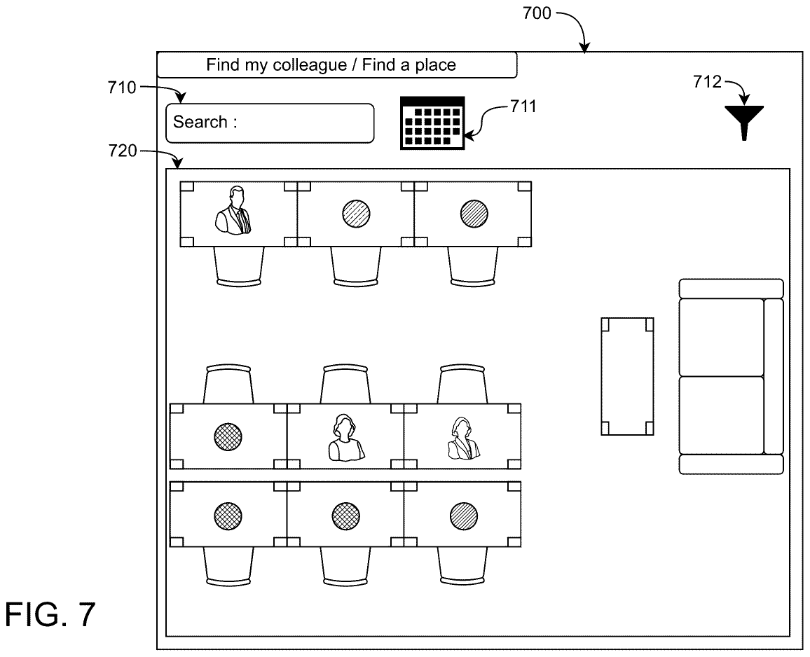

The software application module 240 can comprise a registration submodule 244, which is configured to ensure that relevant information is stored in a database, which can be a local database accessible to the portable device 120 and/or a centralized, organizational database located on or accessible to a server that the portable software application module 240 is capable of communicating with through the registration submodule 244. Relevant information can for instance include a unique identifier corresponding to the closest wireless communication device, a unique identifier corresponding to the portable device itself or to the user identified through the login submodule 241, indications as to whether the portable device and/or associated user are, e.g., arriving at or departing from a position associated with the closest wireless communication device, and timestamps associated with such events, e.g., arrival timestamps and departure timestamps. As an example, the relevant information stored in the database can be these that make it possible to implement the capabilities of the centralized control software submodule 246, as described below and in FIG. 7 to 11.

The software application module 240 can comprise an external device control submodule 245, which is configured to control external devices associated with the closest wireless communication device. The external device control submodule 245 can communicate directly with the external devices and/or can communicate indirectly with them through one or more gateways, as will be described in detail below, in particular with respect to FIG. 3. The instructions sent by the external device control submodule 245 can comprise manual instructions to change settings of an external device sent by the user of the portable device and/or automatic instructions to change settings of the external device to default user-associated values selected by the user and stored in a database.

The software application module 240 can comprise a centralized control submodule 246, which is configured to allow all features allowed by operating a centralized, organizational database accessible by the portable device 120, or alternatively a distributed database operating on one or more portable devices located in the venue that are communicating together to make aggregated data accessible. Such features include for instance displaying the respective locations within the venue of one, some or all the venue users, reserving a location in the venue, and displaying various statistics. The features are described in more detail below, in particular with respect to FIG. 7 to 11. Such features may also only be accessible by a web-based application.

The software application module 240 can comprise a graphical user interface 247, configured to display information and allow users to input information, for instance for the login submodule 241 and for the centralized control submodule 246. As can be appreciated, the graphical user interface 247 can be configured to generate a graphical user interface (GUI) in the form of a web application consisting of code in one or more computer languages, such as HTML, XML, CSS, JavaScript and ECMAScript. In some embodiments, the GUI can be generated programmatically, for instance on a server located within the venue or in the cloud hosting an HTTP server, and rendered by an application such as a web browser on the portable device 120. In other embodiments, the software application module can be configured to generate the GUI via a native application running on the portable device, for example comprising graphical widgets configured to render information received from a server hosting organizational database. In some embodiments, some feature can be implemented with a native GUI and some other features can be implemented in a web application.

The software application module 240 can comprise a pairing submodule 248, which is configured to establish and, in some embodiments, maintain a pairing between a portable device and the closest wireless communication device selected by the device selection submodule 243. In some embodiments, the pairing submodule 248 can further be configured to drop the pairing when unpairing conditions are met. Maintaining the pairing can for instance include sending a “maintain signal” to the paired communication device at a periodic time interval and/or maintaining a bidirectional connection such as a BLE connection with the communication device to indicate that the portable device is still operating and still located at the same place.

The software application submodules are preferably implemented in a high-level programming and/or scripting language, for instance an imperative e.g., procedural or object-oriented, or a declarative e.g., functional or logic, language, to communicate with a computer system. However, they can be implemented in assembly or machine language if desired. In any case, the language may be a compiled or an interpreted language. Each such submodule is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer. Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

FIG. 3 shows an exemplary method of transferring unique identifiers from wireless communication devices to the portable device 320 in order to locate this device in its environment/venue. An exemplary wireless communication device 310 is illustrated in FIG. 3. The wireless communication device 310 comprises different submodules as described in FIG. 2A.

The wireless communication module 310 may be installed under the table or workstation as shown with the wireless communication module 110 in FIG. 1A. The wireless communication device 310 can comprise a casing or housing that can be attached or maintained underneath or behind a workstation. In alternative embodiments, the communication device 310 is shaped and configured to stand on the workstations. The wireless communication device 310 is therefore located closely to the portable device 320 destined to be used on the same table or workstation. This proximity between the portable device 320 and the wireless communication device 310 makes the signal strength (e.g., RSSI) between them generally higher than with wireless communication devices 310 installed on surrounding tables or workstations.

The method uses wireless communication devices 310 positioned at different locations in a venue. In this embodiment, the wireless communication devices 310 broadcasts advertisement signals comprising their unique identifiers/identification-related information. A software application module 340 on the portable device 320 retrieves the advertisement signals and the signal strength of each one. A set of criteria may then be used to locate in which wireless communication device's 310 zone the portable device 320 is in.

A first criterion that may be used is the highest average signal strength (e.g., RSSI) in a given time interval, for example 15 seconds. With the wireless communication device 310 installed under the table and therefore in proximity with the portable device 320, this criterion may often lead to accurate results.

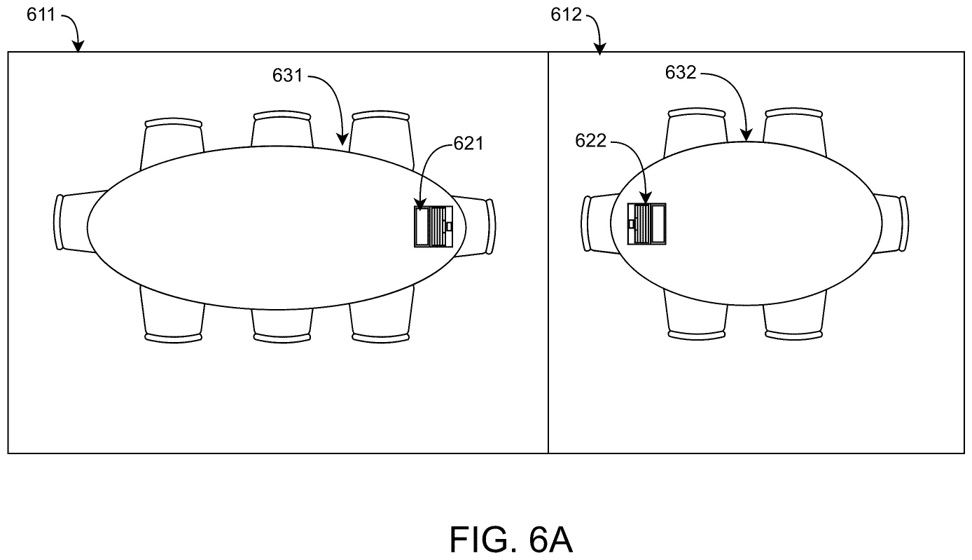

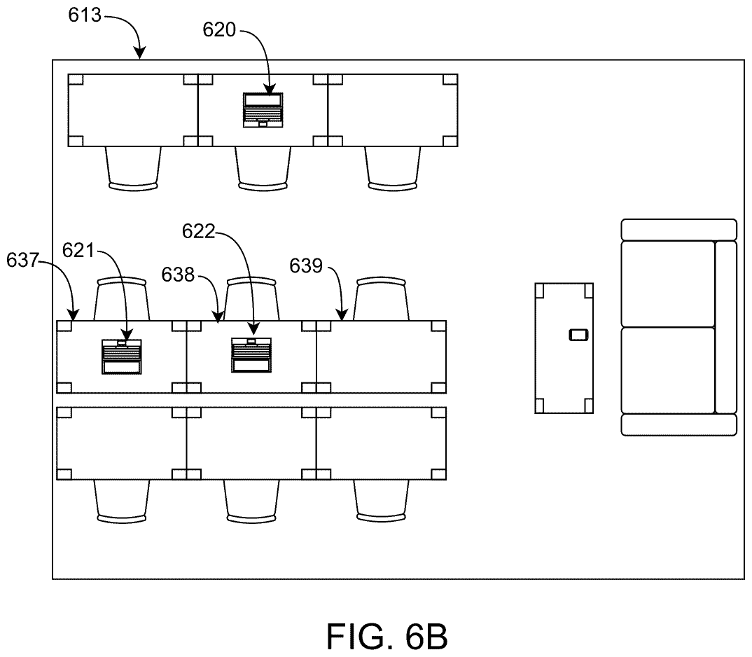

However, in some cases, such as environments/venues with individual desks in proximity, there is a need for more criteria. In such environments, it is possible, once in a while, to detect a stronger signal average from an adjacent table's wireless communication device. Exemplary environment that may present these localization problems are shown in FIGS. 6A and 6B. To ensure this does not happen, an additional criterion may be used, in addition to the highest average signal strength, which is to use multiple time intervals to select a closest communication device (or wireless communication device) among the nearby wireless communication devices. For example, in each time interval, the software application module 340, via for example its device selection submodule, finds the wireless communication device with the highest strength signal and temporarily stores its identification-related information. To confirm the location of the portable device within the venue, and before pushing data into the database 350, the software application module 360 may for example wait for a wireless communication device to have won two consecutive time intervals or two time intervals out of the last three time intervals. Any other numbers of time interval may be used depending on the rapidity of localization that is desired and the length of each time interval. By “winning two consecutive time intervals”, it is meant that the device selection submodule of the software application selects one of the nearby wireless communication devices having the strongest average signal over at least two or more time periods (or time intervals). The number and duration of the time periods can be configured, as will be explained in more detail below. By “nearby wireless communication devices”, it is meant the wireless communication devices that are within the vicinity/range of the portable device. Nearby wireless communication devices are devices that transmit signals, which can include their identifier, and which can be sensed/detected by the portable device.

Additionally, all the identification-related information and their rank in terms of average signal strength in each time interval may be temporarily saved to select the closest wireless communication device based on more advanced criteria, using data from the latest time intervals. By “closest wireless communication device”, it is meant the wireless communication device that should be associated with the portable device, and that allows associating the portable device with a specific location within the venue. In possible implementations, the closest wireless communication device is also the wireless communication device that allows the portable device to control the external devices associated with the workspace/locations in which the portable device is placed. For example, a score may be given to each wireless communication device 310 based on their rank (based on RSSI) and the wireless communication device 310 with the highest score in the last n time intervals is determined as the actual location of the portable device 320, where n can correspond to, e.g., 3 time intervals.

Another criterion that may be used to reduce cross-connection is to determine for each wireless communication device 310 a minimum signal strength necessary to be even considered in the ranking of the average signal strength. This may be useful in environments where some wireless communication devices that are associated with an individual desk or workstation are located near a large room covered by just a few distant wireless communication devices 310. In such environments, there may be some places where the user can use his portable device in the large room but be closer to the wireless communication devices associated with the individual desks than the wireless communication device associated with the large room. In this case, the minimum signal strength of the wireless communication devices associated with the individual workstations can be chosen so anywhere on the desk the portable device 320 receives a signal with a signal strength bigger than the minimum, but anywhere further the signal is lower than the minimum. In this example of the person sitting in the large area, even if a wireless communication device associated with the individual desk has the best average strength signal, it will not be considered in the ranking. This is also useful to limit the size of the areas where a user can be located so users are not localized when they are in zones that are not covered by wireless communication devices.

Additional modifications to the method may be implemented through the software application module to address some challenges proper to the use of laptops and the large number of different models of laptops that exist on the market. A first modification consists of detecting when a laptop is closed so that the localization of the person logged in on this computer can be updated and the external devices 360 can return to their standby state. A desktop application, part of the software application module 340, is necessary on laptops to acquire the advertisements, but this type of application stops running when the laptop is closed. There needs to be a way for the database 350 to receive the updated information even if the desktop application is shutdown. In a possible implementation, a web application can be used, and constantly runs. The desktop application sends a “maintain signal” at a periodic time interval to indicate it is still operating and still located at the same place. When the web application has not received data from a desktop application during more than the defined time interval, the web application detects that the laptop has been closed and can update the information relating to the portable device location, by storing in the database the end of the connection with the wireless communication device 310. The software application module 320 may also send a message to the database 350 indicating that the connection with a wireless communication device is terminated when the signal strength becomes too low or another device appears stronger.

Another method that may be implemented via the software application module 340 in order to be compatible with various portable device models is to dynamically adjust the duration of the time interval of the averaging periods used for measuring or determining the average advertisement signal strength. This implementation may be required as some portable devices, depending on their manufacturing/specifications, will require longer time than others to retrieve/detect at least one advertisement signal from each of the surrounding wireless communication device 310. If the time interval is fixed at a too-short value/duration, slower computers will be hard to locate precisely. Otherwise, if the time interval is fixed at a duration that works for the slowest portable devices, the time required for the portable device to select a closest wireless communication device will too long for the majority of other portable devices. Therefore, in a possible implementation, the method may comprise launching the software application module 340 with a fixed time interval/period for the measurement/determination of the signal strength, and to continuously monitor the number of lost advertisements in the n last time intervals. For example, the software application module 340 may count, for each time interval, how many of the wireless communication devices with the X best averages in the last time interval were not received during the current time interval. A condition can be set such that, if in the last Y intervals, more than a given percentage of lost advertisements were obtained (percentage=(#of loss)/(X*Y)*100%), then the time interval for the average signal strength should be increased. Otherwise, if no advertisement were lost or only an acceptable percentage, the time interval can be decreased to accelerate the localization with this portable device.

In a preferred implementation, the device selection submodule is configured such that the wireless communication devices 310 with the X best averages are used to calculate the number of loss advertisement signals, since the wireless communication devices with a signal strength that is too weak are more likely not to be detected for reasons unrelated to the speed of the portable devices.

Even with the methods described above, in some environments and for some computer models the wireless communication device with the strongest RSSI perceived by the software application module on a portable device may still not be the wireless communication device of the workstation on which the portable device is currently located on. This can be referred as “cross-connecting”. Cross-connections must be limited to ensure the best user experience and accuracy of data from the features described in FIG. 6 to 10 and any other features based on the localization or detection of persons in an environment. Averaging over a longer period of time or using a minimum strength signal may not be sufficient since the cross-connection may be due to conditions that are difficult, impossible or undireable to control, including for instance the radiation profile of the antennas, the geometry of the portable device and the position/orientation of the portable device respective to the wireless communication devices. In these cases, one way to detect the right wireless communication device (the one on the same workstation as the portable device) would be to ensure that the other ones not be considered by the device selection submodule in the software application module. More details are provided below on possible embodiments in which the wireless communication devices can send advertisement signals to be considered by software application modules only when necessary, and change/cease the advertisement signals in some cases where they are not likely to be detected by a new portable device at their position.

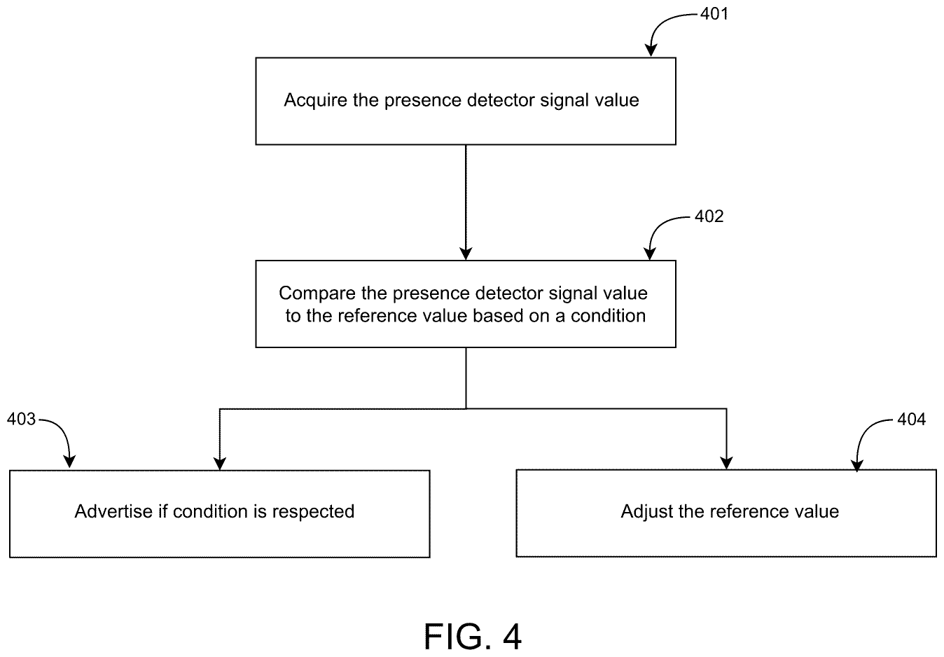

To reduce the number of wireless communication devices who broadcast advertisement signals at a given time, the wireless communication devices could only broadcast if the presence detector indicates the presence of a person in its field of view. By doing so, only the wireless communication devices 310 of occupied workstations in a workspace would broadcast advertisement signals. On days where the office has a low occupancy rate, this would significantly reduce the number of advertisements that the software application module 340 has to process and therefore reduce the chances of cross-connection. Descriptions of FIG. 4 will go into more details on an exemplary process for using the presence detector signals to cease the advertisement signals sent by the wireless communication device 310.

In other embodiments, when the office has a high level of occupancy, a way to reduce the chances of cross-connections occurring can include pairing wireless communication devices 110 with portable devices 320 based on a defined set of conditions, e.g., pairing and unpairing conditions, that could be processed by the software application module 340. Once a wireless communication device 310 is paired with a portable device 320 it may modify or cease its advertisement signal and therefore no longer be detectable by other portable devices. The wireless communication device would return to its previous broadcasting state (detectable by all portable devices) when a given set of conditions to unpair the wireless communication device and the portable device are obtained. Description of FIG. 5 will go into more details on this process and exemplary conditions for pairing and unpairing the wireless communication device 310 and the portable device 320.

In some embodiments, the software application module 340 can retrieve from the database 350 a unique position or location associated with the identification-related information of the wireless communication device, where the unique position may identify a physical position within the venue, for example a building floor and room, and a workstation row and position in the row associated to the wireless communication device. Based on the respective physical locations within the venue, identifications for all external devices 360 associated with these physical locations, and corresponding additional information necessary to establish a connection therewith, can be stored and accessed from the database 350. The additional information may include SSID of the external devices and a wireless communication type to use for specific external devices.

Alternatively, only a subset of identifications of the external devices 360 and corresponding additional information may be stored and accessed via the database, according for example to user preferences. The set of requests used may depend on user preferences, type of device, wireless protocol compatible with the device and other criteria. The portable device 320 may then use the identifications of the external devices 360 and corresponding additional information to automatically connect to one or more external devices 360 with appropriate wireless communication protocols. The connection process depends on the type of wireless communication protocol used by the external devices but may often include an acknowledgement message sent by the external device indicating that the connection was successful. Instructions to the external devices may then be sent based on user preferences or organization preferences. For example, upon entering a vicinity zone and receiving the unique identification of the wireless communication device, a portable device, through the software application module may retrieve, in the database, identification and ways to communicate with the electrically adjustable desk associated with the position. The portable device may then ask the desk to adjust to the preferred height of the user connected on the portable device.

Eventually, wireless communication devices or external devices may be moved and/or replaced from one workstation to another. The database 350 may then store non-accurate information. Different methods may be used to keep the database 350 up to date. For example, when performing a manual connection, using the software application module 340, between the portable device 320 and an external device 360 not associated with the wireless communication device 310 in the database 350, an update of the database 350 may be triggered. The updated database 350 will subsequently allow the software application module to automatically connect to the given external device on subsequent connection attempts at this specific position in the environment.

In possible embodiments, external devices 360 may be activated or controlled by a different device than the portable device 320 in response to someone being located at a specific place. For example, as illustrated in FIG. 3, the software application module 340 can communicate the Device IDs and the instructions that need to be sent to each device to a gateway 370. The gateway may for example receive Wi-Fi messages addressed to specific external devices 360 from a part of the software application module 340 and translate these messages to a wireless communication protocol supported by the external device 360. Such wireless communication protocol can either be mesh communication, such as Zigbee, BLE mesh and Thread or non-mesh such as Bluetooth™ and BLE. In the case of mesh communication network the gateway 370 may include a first gateway, often called the coordinator, and subsequent gateways or devices that relay the information to the right external device 360. Using a gateway 370 instead of the portable device 320 to send the instructions has a first advantage of being compatible with external devices 360 that use a wireless communication protocol not supported by the portable device. Another advantage is to reduce the power consumption of the battery in the portable device 320 by limiting the computing and wireless communications the portable device has to do. On the other hand, Gateways 370 are often devices connected in permanence to a main power outlet, so they do not require the use of a battery. This advantage is only significant in the case where the portable device does not run entirely on the portable device 320 of the user but has a delocalized portion either web-based or on a local server in the office that can communicate the Device IDs and the instructions to the gateway 370.

In some embodiments, it may be desired to obtain occupancy data without the need of installing or using a software application module 340 every portable device 320 that will be used in the venue. Gateways 330 may then be added to the venue and may then scan for all the advertisement signals within their reach and send the information on all wireless communication devices 310 to local servers or remote servers via Wi-Fi, cellular network or other means of communication. The information may then be stored in a database 350. Since the information does not transit by portable devices 320 where users are logged in on a software application module 340, the information stored in the database has no reference to user identities. It may then allow to obtain anonymized occupancy statistics and control some external devices 360, but in this case it could not be based on user preferences. In other embodiments, users may also change a parameter in the software application module to make sure the data that is sent to the database 350 does not include information that could identify the person. The data in this embodiment would also only be anonymized and would not allow all features, but it gives the user the option not to be tracked at all times.

In some embodiments, gateway 330 and gateway 370 may be the same devices while in other cases they may be separate devices. Also, in a venue there may be multiple gateways. Gateways in a venue may be organized in a network configured to allow for mesh communication.

The database 350 may be stored on storage means, such as non-volatile memory, located on the portable device 320, on an accessible local network, or in a remote location accessible with an internet connection, according to various embodiments. For example, one or more servers comprising non-volatile memory may store the database thereon, the servers being accessible within a certain network using an internet connection. Therefore, managing wireless communication devices, and external devices can be performed completely remotely from those devices.

The software application module 340 further provides, as a non-limiting example, functions for wirelessly connecting to external devices 360, functions for defining user preferences, functions for allowing the user to update the database manually and other related functions. In some embodiments, the software application module 340 may further include sub-modules, or functions, for securing the connection between the database 350 and the devices allowed to access and/or edit the database 350. The software application module may also include functions for automatically disconnecting the wireless communication channel between the portable device 320 and external devices 360 when the portable device 320 is moved out of the zone. This may be done with or without the user approval depending on the user preferences or the organization who manages the working space, for example. Additionally, some types of communication protocols need the external device to be in pairing mode in order to connect to them, as for example Bluetooth. The software application module 340 may be configured to put external devices in pairing mode before connecting to it if the software application module has the proper permissions. Further, in some embodiments, the software may additionally put an external device back in pairing mode when disconnecting them from a portable device. In other embodiments, the software application module may further include other features such as battery management.

Now referring to FIG. 4, steps for a wireless communication device with a presence detector are described. A first step 401 may consist of the controller (e.g., 212 in FIG. 2A) acquiring the presence detector signal value from the presence sensor. The presence sensor can for example be an IR sensor or a PIR sensor. The presence sensor signal values depend on whether someone is present in its field of view and the position of this person in this field of view. The signal sent from the presence sensor to the controller may be analogical or digital. Either way, the controller may at a second step 402 compare the presence sensor signal value to a reference value based on a given condition. The reference value may be static (“hard-coded” or always the same) or it may be dynamic as will be explained in step 404. In some embodiments, whether a presence is detected or undetected can depend on a presence condition based on the reference value. The comparison condition between the presence detector signal value and the reference value may for example be a that the presence detector value is greater than the reference value or greater than the reference value plus a given numerical value. In some cases, the condition may also be based on the speed of change of the presence detector value (derivative) to detect someone entering the field of view or exiting the field of view.

As mentioned in FIG. 3, a way to reduce cross-connection may be to configure the wireless communication devices in such a way that they only broadcast when a presence is detected. This can be done with the third step 403 in which the controller would only activate the advertisement signals when the condition of step 402 is respected. As long as the condition is observed, it would usually mean that a person is sitting or present at the desk, and the software application module (340 in FIG. 3) on the laptop of the person should be able to detect the wireless communication device. However, if there are wireless communication devices on adjacent desks that are not occupied by a person, the condition of step 402 would not be observed, and these devices would therefore not advertise/broadcast. The software application modules on laptops would then have fewer advertisement signals to process and could choose the closest wireless communication device with a diminished risk of cross-connection.

A fourth step 404 may for example include adjusting the reference value used in step 402 based on the last presence detector signal value. Depending on the type of sensor and circuitry used, the presence detector signal value when someone is present in its field of view may vary over long periods of time, for example based on external factors such as the battery level, the temperature in its location, and many others. In order to limit the probability of not detecting a presence, or to detect a presence when nobody is there, step 404 may continuously adjust the reference value, for example by using a weighted average, e.g., of past reference values, that gives the last presence detector signal value a given weight in the reference value. As an example only, adjusting the reference value can include aggregating a past reference value, e.g., the most recent previous reference value, and the last measured presence detector signal value, for instance using a weighted sum of the two values. The weight could be chosen based on the system and the sensor. A too-small weight applied to the presence detector signal value may cause that the variations due to the external impacts continue to have a significant influence on the system. However too great a weight may cause not to be able to detect slow changes in the field of view, for example if someone enters slowly in the zone while talking to a colleague. The weight may also vary depending on the signal value versus the previous reference value. For example, if the condition of step 402 is one that the presence detector signal value must be greater than the reference value plus a given numerical value, it may be useful that the reference value follows in the best way possible the empty state signal value which could be defined as the local average value given by the sensor when no one is in its field of view. Considering that some places may be occupied for as much as 8 to 10 hours a day, to keep the reference value near the empty state, a bigger weight may be given to smaller value (which have more chance of corresponding to empty states) and a smaller weight may be give to higher values (which have more chances of corresponding to an occupied value). The weight value may also vary more progressively, for instance by using three or more discrete weight values each associated with a range of difference between the presence detector signal value and the reference value. In some embodiment, the weight value(s) may also be chosen by using a continuous function of the weight in respect to the difference between the presence detector signal value and the reference value. The weight value(s) to apply may also depend on other parameters such as the derivative of the signal, which can be useful when a person sits further form the presence sensor, causing the value to rapidly change, albeit only by a small amount.

Reducing the number of advertisement signals that a wireless communication device has to send also helps increase the lifespan of the product by reducing the average power consumption.

Now referring to FIG. 5, a method for reducing even more the number of advertisement signals in an environment with many wireless communication devices is described. Wireless communication devices need to send their identification-related information to portable devices in order to locate people in the environment or acquire utilization data of the venue. However, there are methods that can be used to confirm the position of a portable device in the environment, pair it with the wireless communication device associated with this place and place the wireless communication device in a paired state that will make him stop broadcasting to all other portable devices. Described herein is a possible way to implement this invention, but it will be understood by those skilled in the art, that many ways can be used to create a pairing between the wireless communication device and the portable device or any other implementation that would result in reducing the number of advertisement signals in the environment by associating wireless communication devices with laptops.

In some embodiments, the wireless communication devices and/or the software modules may be stateful, i.e., have a behaviour that is at least partly defined on a state of the device and/or software module. To distinguish between wireless communication device states and software module states, these can be for instance be named “communication device states” and “software states”. A list of possible states for the communication devices and for the software module may be defined. The list of possible states for communication devices can for instance include a standby state, an unpaired state and a paired state (also named, e.g., “communication device standby state”, “communication device unpaired state” and “communication device paired state”). The list of possible states for the software module can for instance include an unpaired state and a paired state (also named, e.g., “software unpaired state” and “software paired state”). It can be appreciated that other, additional or alternative states can be used, and that functionally equivalent states can be given different names. Each device and software may be configured to have a given, initial state, upon startup-for instance, when the communication device is powered up and when the software is launched or restarted. As an example, the communication devices may be in the standby state upon startup, and the software module may be in the unpaired state upon startup. Based on different conditions as will be described below, both communication devices and the software module can transition from a first state to a second state, thereby “exiting” the first state and “entering” the second state.

A wireless communication device 510 may always broadcast advertisement signals with its identification-related information or use a method as described in FIG. 4 and only broadcast advertisement signals when a condition is met with the presence detector signal. In this second case, there may be a standby state 511 in the wireless communication device which may for example execute the steps in FIG. 4 until the condition of step 402 is respected and then change to the unpaired state 512. These states and state transitions, or changes, would be handled by the wireless communication device controller as shown in FIG. 2A. In the method described herein the unpaired state 511 is a state in which the wireless communication device is not yet paired with a portable device and broadcasts advertisement signals addressed to any portable device in proximity.

The messages sent by the wireless communication devices in the unpaired state 511 may be scanned/received by a software application module 530 running on a personal device of a user. In the unpaired state 531, the software application module receives and processes all the advertisement signals from wireless communication devices in the unpaired state 511 within its reach.

For example, when someone arrives at a workstation, the wireless communication device would transition from the standby state 511 to the unpaired state 512 because the presence detector detects a presence in its field of view. Similarly, when someone arrives, they will most likely open their personal device, for example a laptop, which may launch or activate its software application module in an unpaired state 532. The software application in the unpaired state 532 may then proceed to find the closest wireless communication device 510, e.g., based on a pairing condition based on a set of criteria. Once a wireless communication device answers to one or more criterion, the software application module may transition to the paired state 533. The set of criteria to transition from the unpaired state 532 to the paired state 533 may include without being limited to finding the wireless communication devices with the strongest signal strength (RSSI) or with the shortest time of flight (ToF) depending on the technology. These values may be averaged over a given period of time to ensure a better chance of identifying the right wireless communication device. One or more of the methods described in FIG. 3 may be used at this point as a criterion. For example, the set of criteria may also include the RSSI or ToF of the wireless communication device message being above or below a given threshold. This would allow for example that the software application module waits a bit longer before pairing if the wireless communication device where the person just sat has not yet transitioned from the standby state 511 to the unpaired state 512. Another criterion may be that even if the threshold criteria is not met, the wireless communication device with the strongest average signal strength over a longer period of time may be the one to pair to. Any combination of the criteria described herein may be used.

With the criteria to transit from the standby state 511 to the unpaired state 512 and the criteria in the software application module to go from unpaired state 512 to the paired state 513, there is a higher chance that the software application module will pair with the right wireless communication device.

Once the software application module transitions into the paired state 533, it will send a message to the wireless communication device 510 that observed the pairing condition, the message indicating that it should transition to the paired state 513. The message may be sent by establishing a connection with the wireless communication device or using an advertisement signal with a specific format that will only be recognized by the appropriate wireless communication device. The software application module 530 may also send a message to the server and/or database to indicate a connection with the wireless communication device. As described in FIG. 3, the software application module may continue to send maintain signals to a web application or the server/database as long as it is in paired mode to indicate that it should keep the connection active. The connection in the database will be stopped at a moment when the server has not received maintain signals over a given period of time or when the software application module has sent a message indicating the disconnection, for example when the software application module returns in the unpaired state 532.

In the paired state 513, the wireless communication device may cease to broadcast advertisement signals that can be considered by all software application modules in the unpaired state 532, for instance either by stopping completely to broadcast advertisement signals or by changing a field in the broadcast advertisement signals that the software application modules on different portable devices can detect and therefore not consider this wireless communication device in the set of criteria for pairing. As an example, advertisement signals may include a field indicative of the state in which the wireless communication device broadcasting the advertisement signal is, such that if the field corresponds to an indication that the device is in the paired state, the advertisement signal will not be taken into consideration by the software application module of nearby portable devices. However, it may be desired that the wireless communication device 510 continues to send a message to the software application module on the portable device to which it is paired in order for the software application module to be able to decide when to return into the unpaired state 532 based on another set of criteria. Such criteria may include a rapid change in the paired wireless communication device signal strength or time of flight or these values going past a given threshold. Another criterion may also be that the presence sensor in the paired wireless communication device 510 did not detect any presence in a given period of time. This criterion may be either handled by the wireless communication device who after a given period of time without presence detection would return to the standby state 511 or by the software application module if the wireless communication device changes the message sent based on a detection by the presence sensor. By doing so, the software application module in the paired state 533 could monitor the period of time since the advertisement signals changed until it exceeds a given threshold. Different combinations of criteria described herein may be used.

The software application module in the paired state 533 may still periodically or continuously process all the wireless communication device advertisement signal to validate the pairing, i.e., to validate that its pairing is the right one. The RSSI, ToF and/or other criteria from all nearby wireless communication device may be used to periodically validate the pairing In some embodiments, software unpairing condition (i.e., conditions under which a loss of pairing is determined by the software application module), including the set of criteria for unpairing a current wireless communication device to pair a new wireless communication device, would be stricter since the timing of both devices going into unpaired mode at the same time would not be met. Therefore, to change the pairing to another wireless communication device, the averaged RSSI, ToF and/or other criteria would have to be significantly different between the two wireless communication devices to change the pairing (e.g., significantly higher RSSI or significantly lower ToF) that there is no doubt the wireless communication device currently paired is not the right one.

Another way that the software application module may return into the unpaired state 532 is when the software application module is closed, for example when the portable device is closed. For various embodiments, when the software application module will restart it may either return to the paired mode 533 and validate the set of criteria with the last paired wireless communication device or return directly into the unpaired mode 532 and do the validation on all wireless communication devices in unpaired mode 512 within its reach.

The wireless communication device 510 may then return into the unpaired state 512 if the software application module on the portable device to which it is paired sends a message indicating that it should change to this unpaired state 512 or if it has not received any message from the software application module to maintain the pairing in a given period of time, for example if the software application module is closed.

In some embodiments, the wireless communication device may return to the standby state 511 from the unpaired state 512 after a given period of time in this state, even if the presence sensor still detects a presence in its field of view. It may be useful in environment where a lot of users do not have the software application module running on their portable device or where people often work without their portable device to limit the number of wireless communication devices broadcasting advertisement signals. In some embodiments, the wireless communication device could cease broadcasting for a given period of time after a given period of time in this state, even if the presence sensor still detects a presence in its field of view, with or without a state transition, e.g., with a transition from the unpaired state to a temporary-strandby state, then start broadcasting again after another given period of time, e.g., if a presence is still detected. In some embodiments, the wireless communication device may return in the unpaired state for brief periods either periodically or when a large change in the presence detector signal is detected.

In some embodiments, as mentioned earlier, a way for the software application 530 module in paired state 533 to periodically validate if the pairing with a given wireless communication device 510 is still valid, is to configure the wireless communication device in a way that it will continue broadcasting even if it is paired but change parameters in the message based on the state (paired or unpaired). It may also vary a parameter in the advertisement signal based on the value of the presence detector. By continuing to send messages even in the paired mode, the gateway(s) (e.g., 330 in FIG. 3) can still receive accurate data on the occupancy of the venue and transmit the information to the database via a software application module. Other embodiments are possible to get the same results, such as having separate types of advertisement signals addressed to the software application module on the portable devices and addressed to the gateway(s). The advertisement signal intended for the software application module on the portable device would be used for pairing purposes and would cease or be modified when in paired state 513. Simultaneously, the wireless communication device could broadcast another advertisement signal intended for gateways which would not cease once in the pairing mode 513.

The methods described herein for pairing software application module 530 running on portable devices in the venue with wireless communication devices 510 installed at specific places in the venue are only examples and it will be appreciated by a person skilled in the art that many others could be used with similar results. What these methods allow is for the software application module 530 running on a portable device in the venue to have fewer wireless communication devices advertisement signals to process since wireless communication devices on other desks will likely not send advertisement signals at the same time. Most wireless communication devices on occupied desk/workstations/rooms will already be paired with other portable devices and wireless communication devices on unoccupied desk/workstation/room will not detect presence with the presence detector. Wireless communication devices in any of these situations may therefore not send advertisement signals directed to the software application module in the unpaired state 532. Preferably, the software application module 530 on the personal device of a person who just arrived at a location in the venue would have to process only the message of the wireless communication device associated with this location in the venue since all other wireless communication devices within reach would be either in the standby state or the paired state. However, since there are often chances that the software application module will have to process more than one message from wireless communication devices in unpaired state 512, a set of criteria to find the wireless communication device associated with the location of the person in the venue must be followed before going into paired state 533. Events that could result in more than one wireless communication devices transitioning to the unpaired state 512 simultaneously may for example be two persons arriving at nearby desks within a time interval shorter than the usual pairing time or having a person sitting or standing in the field of view of a wireless communication devices presence detector but not using a portable device.

Another reason why the set of criteria for going into paired state 533 and the set of criteria for returning to the unpaired state 532 may be desirable is the fact that a person may not be detected by the wireless communication device presence sensor at the location where its portable device is located for various reasons including the person leaving the place but leaving their personal device behind, and the person using the desk/workstation but not being in the field of view of the presence sensor. In this case, the portable device may be in the unpaired state 532 and needs criteria not to pair with any wireless communication device in the unpaired state 513 that are not at its current location in the venue.

Communications between the wireless communication device in paired state 513 and the software application module in paired state 533 that are paired together may be a bidirectional connection such as a BLE connection (central peripheral) that is maintained until the pairing is ceased by either the software application module 530 or the wireless communication device 510. The pairing states may also be maintained by creating a new connection at a given time interval and ceased following a message indicating to cease the pairing or by the absence of new connections for a given time interval. Another way to maintain the paired states could be by advertisement signals from the wireless communication device 510 and/or the software application module 530 being recognizable by the other. The message may indicate to keep the pairing or to cease the pairing. If the wireless communication device has received no message in a given time interval, a communication device unpair condition can be met, causing the wireless communication device to consider that the pairing has been lost.

FIG. 6A shows an exemplary environment in which the system and methods described herein can be deployed or used. A first and second meeting rooms 611 and 612 are located next to another in a working environment, such as an office building. Under the first meeting room table 631 and the second meeting room table 632 are installed one or more wireless communication devices to create vicinity zones for portable devices of people attending meetings or using the meeting rooms. In this example, a person is using a portable device 621 in the first meeting room. When this person enters the vicinity of the wireless communication device, one or more of the methods described in FIG. 3 to 5 are used to send the identification-related information of the wireless communication device to the portable device 621. Using a software application module the portable device 621 may retrieve this identifier and interact with a local database and/or an organizational database to allow a plurality of features.

The method described in FIGS. 4 and 5 have the advantage of limiting the number of wireless communication devices that the software application module on the portable device 621 has to process and choose from and therefore limit the chance of selecting a wireless communication device associated with the second meeting room 612. Depending on the methods implemented, the software application module may only have to process messages from wireless communication devices who detect human presence in the field pf view of its presence sensor and/or from wireless communication device who are not yet paired with a software application module. Without these methods, in some office configuration and with some personal device models, it may happen that a wireless communication device in room 612 would appear to have the strongest signal strength for the personal device 621. In FIG. 6A it may happen for example that a wireless communication device under the table below the portable device 622 is seen as the closest one by the portable device 621. There is therefore a need that wireless communication devices only broadcast advertisement signals for all software application module when necessary (when detecting human presence and when not already paired with another personal device).

In the case of a meeting room with multiple seating place, a way to implement methods described in FIGS. 4 and 5, is to install a wireless communication device at each place where a person could sit. In doing so, the wireless communication device would go into unpaired mode (512 in FIG. 5) whenever someone sits in front of its presence sensor and if that person's personal device has the software application module installed, it can get paired with the wireless communication device. In larger meeting rooms, it may make more sense to reduce the number of wireless communication devices to install in the room, but still keep the pairing process with portable devices and wireless communication devices. A way to do so is to use a presence sensor that is capable of detecting the number of persons present in a room at a given time, for instance a door counting solution. The number of persons present in the room would be the maximum number or pairing that the one or more wireless communication devices in the room can keep. The number of pairing could either be periodically shared with the wireless communication devices in the room via a gateway or be handled by the software application module running on the personal devices in communication with a centralized part of the software application module, for example in the cloud. This part of the software application module could for example approve pairings between portable devices and wireless communication devices in the room until the number exceeds the number of people counted by the door counting solution.

Once a software application module on a portable device pairs or associate with a wireless communication device, it can send the information into the database to identify in which meeting room the wireless communication device, and thus the portable device, is located in. This information can then allow to search all wirelessly controllable external devices or systems associated with this meeting rooms. Such external devices or systems may for example be the local lighting systems, the local heating/cooling system, electrical blinds on windows and also audio and visual devices like a television, a monitor, a projector, speakers and microphones or a centralized audio-visual system. Once these devices are identified, the portable device may save this information and automatically attempt to wireless connect to some or all of these devices. Once the connection is established, various controls can be sent depending on the type of device and the preferences previously set. Controls may be as simple as on/off activation or may also be more complex like activating only some components/features of the external device. For example, for a local lighting system, only partial lighting may stay activated when nobody is located in the meeting room, but full lighting may be activated once a portable device enters a vicinity zone, retrieves the lighting system identification and connects to it. Electronically dimmed lights may allow more precise control such as changing the lighting intensity to 50%. The software application may require a login/sign-in in order to have the user identification and preferences.

One of the advantages of the system and methods described herein is the acquisition of the precise location of the portable device 621. Since all the wireless communication devices in the first meeting room 612 are associated with this meeting room, only the devices and systems in this meeting room are controlled, and none of other meeting rooms, like the second meeting room 612. Furthermore, there is no need for manually managing wireless connections to one or more different devices.

Other features include adding information in the database for occupancy data gathering such as the wireless communication device ID, the time of connection, the user identifier and the time of disconnection. This allows for example to see in real time which meeting rooms are occupied by one or more active users or where a specific user is located in the workspace. This information can be displayed in a software application module interface in the form of a map of the floor with a colour map or simply a list showing which rooms are currently occupied. This occupation status may then be compared to the reservation status to see if the room is actually used when it is reserved. The time at which the portable device quits the vicinity zone may also be noted in the database. This can later allow managers to see the occupancy rate of all their meeting rooms equipped with wireless communication devices and much more information by cross-referencing with other data. For example, managers could obtain a report showing the occupancy rate of meeting rooms depending on their capacity (4 places, 6 places, 8 places) or their position in the workspace.

In some embodiments, the portable device 621 may be inactive, which would suggest that nobody is currently in the room. In this case, some organizations can set preferences according to which the software application module or a part of it, like a plug-in program, controls the devices and systems in the room to return to their default state. For example, when a portable device becomes inactive for a few minutes or one hour, the lighting system may close or return to lower intensity.

In a pandemic context, the precise localization offered by the invention can also be useful when someone who visited an environment gets a positive test. The organization may then notify other persons who were at some point near or in the same room as the infected person. In many cases, the organization may notify everyone in the building, but it may also use the location information to notify only people that were in the vicinity of the infected person, such as for example every person that used a station in a given radius of the station associated with the infected person.

FIG. 6B shows another exemplary environment in which the invention and methods described may be used. Similar methods as the ones described in FIG. 6A may be useful in a workspace environment with many desks and workstations in a room 613 that can be reserved and used by anyone. In these environments, employees can work at different places every day and work near the people they want to, thereby enhancing collaboration. However, workstations may need adjustments every time an employee wants to use it, such as the height of the desk, the adjustments of the chair, the lighting controls and also local heating/ventilation systems controls. The system and methods described herein allow the portable device to locate itself precisely at the workstation and control wirelessly some external devices and systems associated with user preferences or last parameters used. When a portable device 620 enters the vicinity of a wireless communication device installed on/under one of the workstations 637 to 639, the portable devices 620 to 622 may retrieve its identification-related information with a software application module and use it to interact with a database and offer various features to the employees or the managers coming from the precise localization this invention allows. The position of portable devices 621 and 622 show another example of how methods of FIG. 4 and FIG. 5 can help reduce chances of cross-connection (identifying a portable device to the wrong location). When a person with portable device 622 arrives at a central workstation 638 as shown herein, the portable device may in some case detect stronger RSSI from wireless communication devices at nearby desks than the one it is currently above. This can be more frequent with some laptop models than others and it can also depend on other objects in proximity. To reduce the chance that this portable device would send the wrong information in the database, there is a need to limit the number of advertisement signals when desks are unoccupied or if the wireless communication device of a desk has already paired with the software application module of another laptop, for example personal device 621 with the wireless communication device of the workstation 637.

FIG. 7 shows another exemplary feature that benefits from the precise localization of people in their environment, which is a user interface allowing the reservation of places and a way to find your colleague in a work environment with no assigned desks. FIG. 7 shows an exemplary user interface 700 in the software application module to help find colleagues in a workspace or to find available places to work. A search bar 710 may be included to enter the name of a colleague. When a user enters an employee's name in the search bar, the database can be interrogated to see if this employee has an active connection (e.g., is still in a vicinity zone) with a wireless communication device and if so, where is located this device. The results would then appear in the result window of the user interface 720. An exemplary result window is shown which would show for a part or the entirety of the workspace the people currently in a vicinity zone. This may include, for example, their picture or their name displayed on the associated workstation. In other embodiments, results may be displayed in a list. The interface may also show where employees were last connected and the time since their last disconnection if they are not currently in an active connection (not in a vicinity of a wireless communication device). The graphical user interface is thus configured to display respective positions within the venue of at least some of the users.

The graphical interface showing the current location of users in the venue may be used for example as a way to connect with colleagues via videoconference means. Calls could be triggered by selecting the person's face on the map. The call would then be directed to the person's portable device or to an audiovisual system near the location of the person.

In some embodiments, some users may have the option not to show their name and/or their picture. In this case, a red circle or another pictogram may be used to indicate that the workstation is currently used by someone without telling who it is. The result window 720 can be useful to help employees find available places without needing to physically move to this location and search available places. Other colours or pictograms may be used to indicate other information. For example, yellow circles may be used to indicate a reserved but non-occupied workstation. Green may for example be non-reserved and non-occupied places.

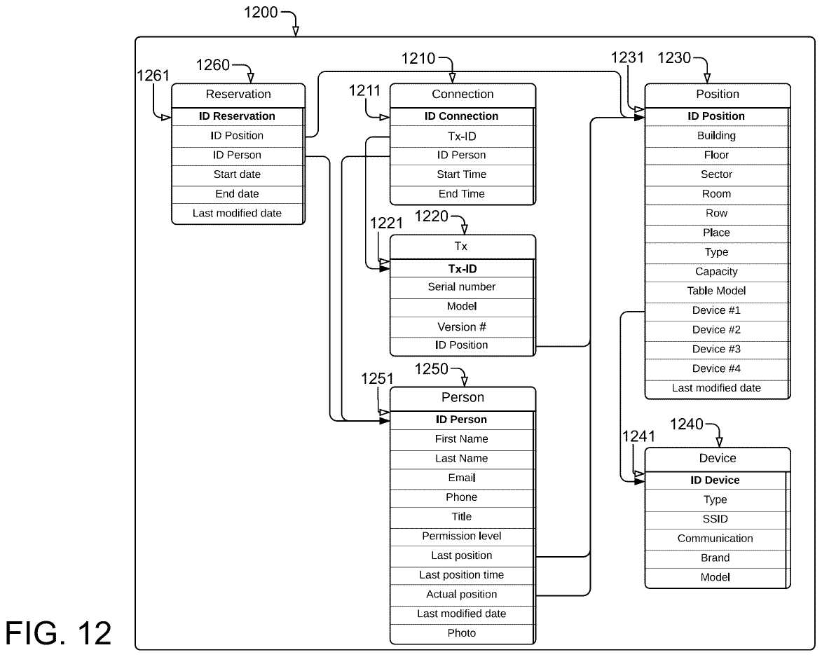

Other tools may be included in the user interface 700. For example, a filter section 712 may allow the user to search for non-occupied places that include specific devices or systems. For example, a user may only want to search workstations with an electrically adjustable desk. The filter section 712 may also be used to only show a specific group of colleagues in the interface, such as an engineering team. The filter section may also allow selecting another building or another floor in a building for companies who have multiple buildings and floors. The calendar section 711 is included to show that the same interface that can help find a colleague or a place to work in real time can also allow for the reservation of a working station at a future time. When trying to reserve a station, the filter 712 may also be used to filter for specific external devices, and employees having already reserved a place may be shown to help the user choose a place close to another place reserved by a colleague, to help collaboration with some colleagues. Once a reservation is made, a new entry is created in the database as described in FIG. 12.

In some embodiments, the same interface or a similar interface may also be used to make it possible for a user to manually check-in, e.g., at a desk or in a room, instead of using the software application module to locate them. As an example, if the localization of the user is not accurate, the user could correct it using this interface.

The user interface is only shown as an example. There are many ways to create an interface with similar features and similar ways to use the localization methods described herein to obtain similar features regarding the localization of colleagues and available workstations.

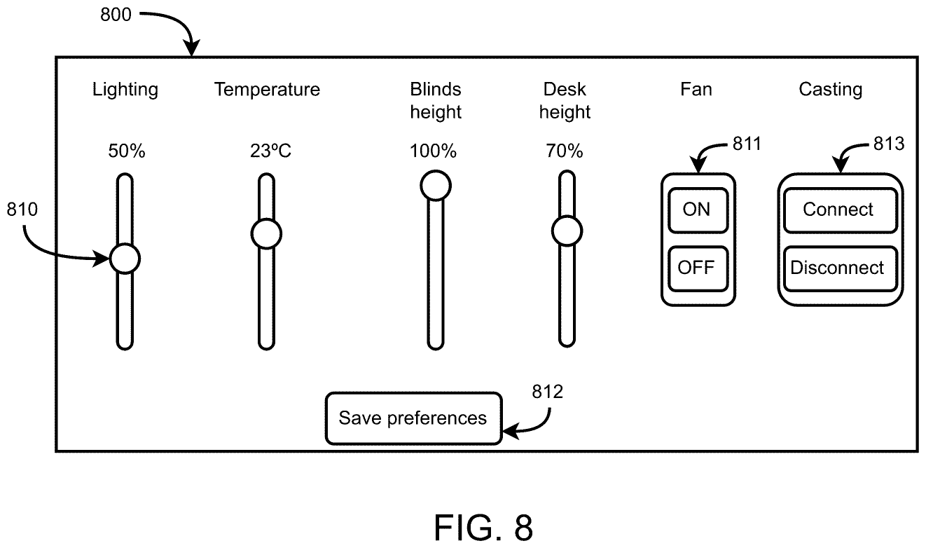

FIG. 8 shows another exemplary user interface in a software application module that offers a centralized control of all the external devices and systems associated with the position of the user and its portable device in an environment. The user interface 800 includes ways for the user to control various devices and systems such as sliders 810 and on/off activation buttons 811. The type of control may depend on the type of device and what the wireless communication controls allow. The software application module, which may be installed on the portable device of a user, may have locally stored the preferences of the user for each type of devices and systems to control. It may also request these preferences in a web-based database. Once this information is retrieved, the software application module can establish a wireless communication channel with each device or use the one already established and send the control parameters to adjust and/or control the external devices. The user may also manually change the parameters using the user interface to adjust the external devices. In such a case, or whenever there is a change in the controls on the user interface, the software application module communicates with the associated device and sends a new control parameter to adjust.

In some embodiments where user preferences are saved in a database regarding the user preferred controls for various types of devices, a “save preferences” button 812 may be included in the user interface 800. This button may appear greyed out when the user did not manually change controls and appear ungreyed out when a change was made. The user may then decide to push on the “save preferences” button to save the current parameters in a database and have the plug-in retrieve these parameters next time his portable device enters any vicinity zone.

One of the advantages of the system and methods described herein is its capacity to precisely locate in the environment, any portable device and/or associated user connected with a wireless communication device, and the identification of only the relevant devices and systems associated with this position using a database. Using the system described herein, the external devices are controllable without having to search through long lists containing all the devices within wireless communication reach, which can include a lot of workstations and rooms. Therefore, an added advantage of the system and methods described herein is an increased efficiency in getting ready to work at a workstation or meeting room.

In the case of a meeting room, the identification-related information of many wireless communication devices may point to the same external devices in the database. In this case, the organization may allow every portable device connected to one of those wireless communication devices to control the external/peripheral devices and systems or alternatively just the portable device of the user who reserved the room. Also, there may be ways to cast to a TV, projector or another device to display content. Connect/disconnect buttons 813 can allow multiple users in the meeting room to start casting or stop casting easily using the user interface. This allows for more dynamic and efficient meetings where people do not need to exchange HDMI wires to one another or search through long lists of casting devices before connecting to the right one, increasing the efficiency of such meetings.

In exemplary embodiments, the user interface according to any embodiment described herein may be included in a plug-in application module and always run as a background process on the portable devices once activated.

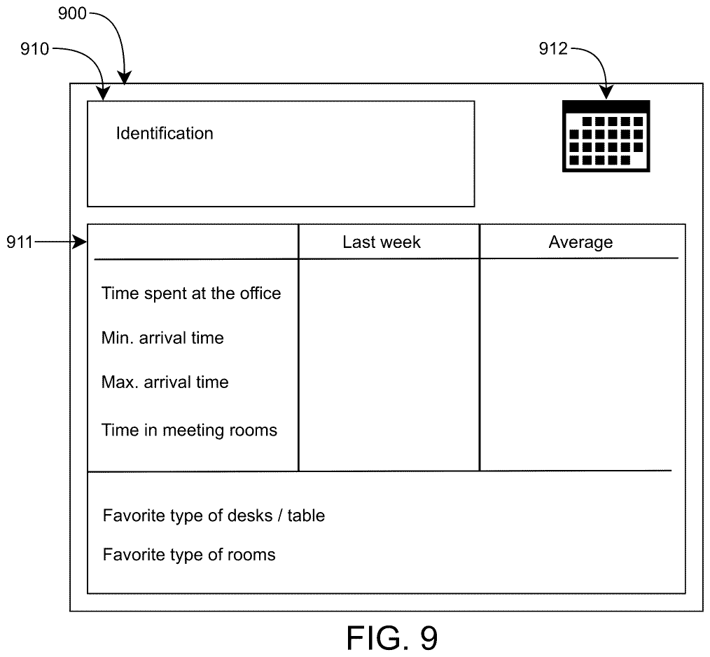

FIG. 9 shows an exemplary report on an employee that managers may consult and that contains processed or unprocessed data gathered using the system and methods described herein. The personal information user interface 900 may contain a section for the employee identification 910 and a section containing additional information on the employee 911. The information may for example be the time spent at the office during a given week, the earliest and latest time of the first connection every day of the week, the amount of time in meeting rooms, and much more. It may also contain the place where the employee is the most often. A calendar section 912 may also be used in the user interface to select custom periods of time for which the manager wants information on the employee.

Similar reports may also be generated on a larger group of people, for example department, teams or all the employees that a manager manages, to get more general data on the group of people. Similar reports may also be generated for customers or groups of customers with similar demographic characteristics in other environments like coffee shops or restaurants.

The time of connection and disconnection (pairing and unpairing if used) can also be useful for time tracking and such information can be linked with other business-wise systems, such as human resources systems. For example, a specific meeting can have a given time code and by entering and quitting the vicinity of a wireless communication device during this meeting, the time log is automatically filled in the timesheet of the employee. Time logs for the beginning of the day and the end of the day can also be filled by using information generated by the methods described herein, such as associating the first time the portable device of a user enters a vicinity zone for a specific day as the beginning of the day, and the last time the portable device quits a vicinity zone as the end of the day. The user could, of course, correct possible errors, but this would give a first guideline to help make the timesheet.

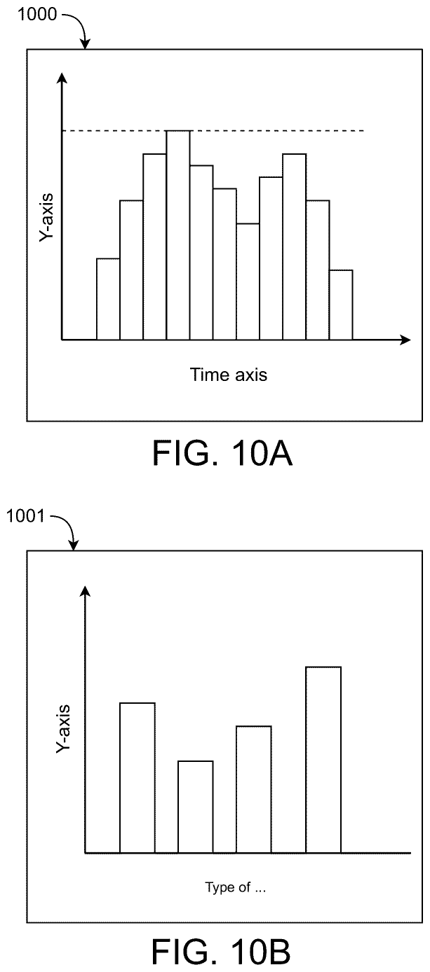

FIGS. 10A and 10B shows other exemplary reports using the data from the connection and disconnection to wireless communication devices in an environment. A first type of report is a time axis graph 1000. In this type of graph, the X-axis/horizontal axis range and how to display it can be chosen by the manager depending on his/her need. For example, the X-axis can be separated into time intervals of a workday. The Y-axis/vertical axis may be the occupancy in terms of the number of people present or the percentage in comparison to maximal occupancy. It may also be the average time spent in the environment. Filters may also be applied for example to see only the meeting-room occupancy and not the whole workspace occupancy or only to a specific type of table, workstation, rooms or type of persons since the connection entries in the database also contain the person identification.

For example, a coffee shop manager may use a time axis graph 1000 to identify which days of the week the occupancy is the highest to help with its work shift schedule or digital marketing campaign. Further analysis may use external data such as sales made for each of these days to draw better conclusions.

A second type of graph is a histogram 1001 where the X-axis/horizontal axis contain types of a variable which we want to analyze. Depending on the environment to analyze, the X-axis may for example be types of tables, types of meeting rooms, types of desks, types of customers, the age of the persons, the department, etc. The Y-axis/vertical axis may be the occupancy in terms of the number of people present or the percentage in comparison to maximal occupancy, the average time spent in the environment, the average time of each connection, the favourite type of table, room, or desks. Not all the X-axis examples named here can be used with all the examples of Y-axis but are only provided as examples of the types of report that the data gathered from the system and methods could allow.

Bar graphs are shown in this figure, but other types of representation can obviously be used, such as tendency lines, pie charts and much more. Basically, any report that may help the managers take better decisions using the data gathered from the methods described in previous figures can be integrated in a software application module accessible by managers and other persons with permissions. The graph generation and consultation can be a part of the software application module, but only be accessible by authorized personnel.

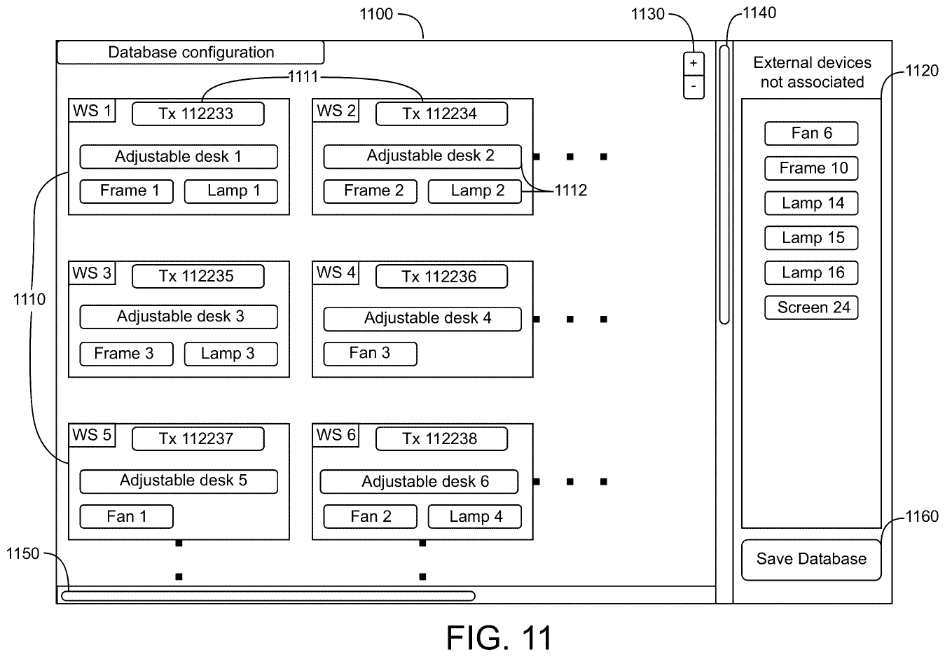

FIG. 11 shows a possible embodiment of another page or pane 1100 of the user interface allowing database configuration. Using the page 1100, a user may associate one or more external devices to one or more wireless communication device, which may be located at a same working station or table for example. This figure shows an exemplary way to do this, but various methods may be used. In FIG. 11, as an example, six different working station blocks 1110 and one or more associated wireless communication devices 1111 are displayed. A certain number of external devices 1112 may also be associated with the working station and thus with the one or more wireless communication device. Peripheral devices may also be associated with the working stations using the same user interface.

The user may drag and drop wireless communication devices 1111 and external devices 1112 from one working station to another. The external devices not-associated list 1120 may also be used to drag external devices not currently associated to any working station and drop them on a chosen working station.

Other features may be used to simplify visualization of the working station such as a zoom bar 1130, vertical slider 1140 and horizontal slider 1150. In some embodiments, the working station blocks 1110 may be placed in a way to represent the physical layout of an office or workplace. The working station block 1110 may also adjust in size in the user interface depending on the number of external devices 1112 and wireless communication devices 1111 to display. Working stations may be places where people work, conference rooms or others, as examples.

A “Save Database” button 1160 may be used to manually update the database. In some embodiments, the button may be greyed out when no changes were made since the last save and become ungreyed out, or enabled, when changes are made. The user may click on it to save the changes to the database.

FIG. 12 shows an exemplary structure of a database in order to provide the features described in this document. The portion of database 1200 shown may be included inside a larger database depending on the organization needs. Those skilled in the art will understand that there are many ways to build a database to produce the same outcome, so this specific embodiment is non-limiting to the scope of the present application. The portion of the database 1200 shown includes six entities which are the connection entity 1210 wireless communication device entity 1220, the position entity 1230, the device entity 1240, the person entity 1250 and the reservation entity 1260. The connection entity 1210 has a unique connection identifier 1211 (primary key). This unique identifier allows access to all the connection attributes such as the wireless communication device identification, the person identification, the start time and end time which is the time the portable device of the person enters and quits the vicinity zone of the wireless communication device. The table associated with this entity is the one that will have a new entry every time someone enters a zone. These entries allow the real-time finding of colleagues or of places available to work. It will also allow various post-analyses and reports that managers may want to use to help their decisions.

The wireless communication device entity 1220 has a unique wireless communication device ID 1221. This unique identifier allows access to all the device attributes, for example its serial number, its model, its firmware version number, and a unique identification of the position of the wireless communication device (ID Position). Other attributes may be included in this entity if needed.

The ID position identified from the wireless communication entity 1220 is the unique identifier 1231 of the position entity 1230. When retrieving this ID position unique identifier 1231, all the attributes of the position entity can also be retrieved. The position attributes describe the physical location of a place in a given space, such as an open-space working environment. For example, the attributes describe the position of a workstation, a desk, a table or a specific place in a meeting room, including the building, floor, room, row, table and place at the table. Other combinations of attributes may be provided in other embodiments. The attributes of the position entity may also include unique identifier for all the external devices (or peripheral devices) that are located at this position. For some more advanced analytics such as analysis on the favourite type of table or type of rooms, the database may also need to include some entities on these subjects.

The unique identifier for an external device 1241 retrieved can be used to retrieve additional information on the external device such as a device type and a communication protocol. The additional information can be found in the device entity 1240. The attributes of the external device entity may include the service set identifier (SSID) of the device or any identifier needed to connect the portable device to the external device. It may also be possible to use this identifier as the unique identifier of the external device in some embodiments comprising further database entities. The attributes of the device entity also include the type of communication to use, such as Wi-Fi, Bluetooth or any other communication protocol needed. Another attribute may be the type of device, for example an electrical desk, a lighting system, or visual and audio devices. Other attributes may include the brand and the model of the device.

The person entity 1250 has a unique person identifier 1251 which may be for example a numerical identifier or an e-mail address. Attributes may include the name of the person, his department, his title, permissions or access and where this person is actually connected. In a working environment, all the attributes shown may also be kept in a separate database since the organization may already have many of these information on its employees saved somewhere. User preferences may also be indicated in this entity or point to other entities that would allow to retrieve this information.

The reservation entity 1260 creates a unique reservation identifier 1261 every time someone makes a reservation in the software application module. Some attributes need to be saved for each reservation such as the position that the person reserved, the identification of the person, from when to when the person wants to reserve the place and the date of creation or modification of the reservation.

FIG. 12 further shows an exemplary embodiment of the process of retrieving additional information associated to the external device starting from the identification-related information of the wireless communication device, or its unique identifier (Tx ID), and allowing accessing the ID and communication type for all devices located at the workstation associated to the wireless communication device.

When a wireless communication device is moved to another position, the position attribute of the wireless communication entity 1220 should be updated. When devices are moved to a new position, the device identification will be added to the unique position identifier 1231 line in the position entity 1230 and erased from the old unique position identifier if it was already in the database.

The present application provides an advantage on the preciseness of the localization by presenting methods for reducing the number of wireless communication devices to which portable device can be associated with a given time by using a presence sensor in the wireless communication device and different states in the wireless communication module controller and software application device. Localization methods using portable device often present major challenges when it comes to being compatible with all device models that exist. Directionality of antennas and speed of processing wireless communication messages are different on every portable device and there is therefore a need for more precise and adaptive methods as the ones described in this application.

The present application also provides an advantage over prior art for the localization of people is the identification of the person. Many solutions acquire only anonymized occupancy data while the present application allows for both anonymized occupancy data and personalized data and related features. Some methods such as sensors installed in office chairs allow knowing the occupancy of some space, but do not allow to identify who is where. Also, chairs are more easily moved from one place to another than wireless communication devices fixed under working station and can therefore be inadvertently moved into another location, giving false information regarding occupancy of a desk/room. Other existing solutions use video camera, but these methods are often perceived as intruding into the privacy of people and do not offer the option of anonymized data for the user or organization who use this type of solution.

Furthermore, the system and methods described herein do not necessitate additional devices connecting to the wireless network (Wi-Fi) since laptops are used for this purpose. Other methods may need to have each device or sensor connected to a local network.

Also, the hardware combined with a software application module and a database as described herein advantageously allows for large data collection and user/organization personalization for the interaction with external devices.

While the above description provides examples of the embodiments, it will be appreciated that some features and/or functions of the described embodiments are susceptible to modification without departing from the principles of the operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A system for wirelessly locating a plurality of users in a venue via their respective portable device, the system comprising:
a plurality of stateful wireless communication devices positioned at different locations in the venue, each comprising:
a presence sensor configured to measure a presence detector signal value indicative of a presence being detected or undetected in a field of view of the presence sensor, and
a communication module configured to broadcast an advertisement signal at a set frequency when in a communication device unpaired state;
a database; and
a stateful software application module, each portable device being configured to execute the software application module, the software application module comprising:
a communication device detection submodule configured to detect nearby wireless communication devices by the portable device when in a software unpaired state, and
a communication device selection submodule configured to select a closest wireless communication device among the nearby wireless communication devices detected by the communication device detection submodule.

2. (canceled)

3. The system of claim wherein possible states of each of the wireless communication devices comprise:
a communication device standby state, being an initial state of each stateful wireless communication device upon startup;
the communication device unpaired state; and
a communication device paired state, wherein possible states of the software application module comprise:
the software unpaired state, being an initial state of the software application module upon startup; and
a software paired state.

4. (canceled)

5. The system of claim 3, wherein each wireless communication device is configured to transition from the communication device standby state to the communication device unpaired state in response to the presence detector signal value corresponding to the presence being detected in the field of view of the presence sensor.

6. The system of claim 5, wherein:
the communication device detection submodule is configured to detect identifiers broadcast by the nearby wireless communication devices and measure a proximity indicator associated with each broadcast during at least one time period when the software application module is in the software unpaired state; and
the communication device selection submodule is configured to aggregate a plurality of proximity indicators to select the closest wireless communication device among the nearby wireless communication devices by a pairing condition.

7. (canceled)

8. The system of claim 3, the software application module comprising a pairing submodule configured to establish a pairing between a portable device and the closest wireless communication device, wherein in response to establishing the pairing the software application module transitions from the software unpaired state to the software paired state and the closest wireless communication device transitions from the communication device unpaired state to the communication device paired state.

9-12. (canceled)

13. The system of claim 3, wherein each wireless communication device is configured to broadcast the advertisement signal when in the communication device paired state.

14. The system of claim 13, comprising at least one gateway configured, in response to receiving the advertisement signal from one of the wireless communication devices, to transmit at least the state of the wireless communication device to the database.

15. The system of claim 3, wherein each wireless communication device is configured to transition from the communication device unpaired state to the communication device standby state after a predetermined duration in the communication device unpaired state.

16. The system of claim 3, wherein each wireless communication device is configured to cease broadcasting the advertisement signal temporarily for a first predetermined duration after a second predetermined duration when in the communication device unpaired state with the presence detector signal value corresponding to the presence being detected in the field of view of the presence sensor.

17. (canceled)

18. The system of claim 3, wherein the presence sensor is configured to acquire a count of a number N of users in a room, a subset of the wireless communication devices located in the room being configured to transition from the communication device unpaired state to the communication device paired state once the subset of the wireless communication devices is paired with N portable devices.

19. The system of claim 3, the software application module comprising a registration submodule configured, in response to entering the software paired state, to transmit at least one of an identifier corresponding to the closest wireless communication device, and an identifier corresponding to the portable device to the database.

20. The system of claim 19, wherein the software application module further comprises a login submodule configured to identity a user using the portable device, and wherein the registration submodule is further configured, in response to entering the software paired state, to transmit an identifier corresponding to the user to the database.

21-22. (canceled)

23. The system of claim 1, wherein the presence detector signal value is indicative of a presence being detected in a field of view of the presence sensor if the presence detector signal value meets a presence condition based on a reference value, wherein at least one of the wireless communication devices is configured to adjust the reference value periodically.

24-28. (canceled)

29. A method for wirelessly locating a plurality of users in a venue via their respective portable device, the method comprising:
measuring, by a presence sensor of each of a plurality of stateful wireless communication devices positioned at different locations in the venue, a presence detector signal value indicative of a presence being detected or undetected in a field of view of the presence sensor;
broadcasting, by each of the plurality of stateful wireless communication devices, an advertisement signal at a set frequency when the wireless communication devices is in a communication device unpaired state;
detecting, by a stateful software application module running on each portable device, nearby wireless communication devices by the portable device when the software application module is in a software unpaired state; and
selecting, by the software application module, a closest wireless communication device among the nearby wireless communication devices.

30. (canceled)

31. The method of claim 29, wherein possible states of each of the wireless communication devices comprise:
a communication device standby state, being an initial state of each stateful wireless communication device upon startup;
the communication device unpaired state and a communication device paired state, wherein possible states of the software application module comprise:
the software unpaired state, being an initial state of the software application module upon startup; and
a software paired state.

32. (canceled)

33. The method of claim 31, comprising each wireless communication device transitioning from the communication device standby state to the communication device unpaired state in response to the presence detector signal value corresponding to the presence being detected in the field of view of the presence sensor.

34. The method of claim 31, comprising:
detecting, by the software application module, identifiers broadcast by the nearby wireless communication devices and measuring a proximity indicator associated with each broadcast during at least one time period when the software application module is in the software unpaired state; and
aggregating, by the software application module, a plurality of proximity indicators to select the closest wireless communication device among the nearby wireless communication devices by a pairing condition.

35. (canceled)

36. The method of claim 31, comprising establishing, by the software application module, a pairing between a portable device and the closest wireless communication device, wherein in response to establishing the pairing the software application module transitions from the software unpaired state to the software paired state and the closest wireless communication device transitions from the communication device unpaired state to the communication device paired state.

37-39. (canceled)

40. The method of claim 31, comprising ceasing, by each wireless communication device, broadcasting the advertisement signal in response to entering the communication device paired state.

41. The method of claim 31, comprising broadcasting, by each wireless communication device, the advertisement signal when in the communication device paired state.

42. The method of claim 41, comprising transmitting, by at least one gateway, at least the state of the wireless communication device to a database in response to receiving the advertisement signal from one of the wireless communication devices.

43. The method of claim 31, comprising transmitting, by the software application module, at least one of an identifier corresponding to the closest wireless communication device, an identifier corresponding to the portable device, and an identifier corresponding to a user associated with the portable device to a database in response to entering the software paired state.

44-45. (canceled)

46. The method of claim 31, comprising transitioning, by each wireless communication device, from the communication device unpaired state to the communication device standby state after a predetermined duration in the communication device unpaired state.

47. The method of claim 31, comprising ceasing, by each wireless communication device, broadcasting the advertisement signal temporarily for a first predetermined duration after a second predetermined duration when in the communication device unpaired state with the presence detector signal value corresponding to the presence being detected in the field of view of the presence sensor.

48. (canceled)

49. The method of claim 31, wherein the presence sensor is configured to acquire a count of a number N of users in a room, comprising transitioning, by a subset of the wireless communication devices located in the room, from the communication device unpaired state to the communication device paired state once the subset of the wireless communication devices is paired with N portable devices.

50. (canceled)

51. The method of claim 31, wherein the presence detector signal value is indicative of a presence being detected in a field of view of the presence sensor if the presence detector signal value meets a presence condition based on a reference value, comprising adjusting, by at least one of the wireless communication devices, the reference value periodically.

52-56. (canceled)
